(19) United States
(12) Patent Application Publication
(10) Pub. No.: US 2019/0130477 A1
(43) Pub. Date: May 2, 2019

(54) SYSTEMS AND METHODS FOR MANAGING CERTIFICATES OF TRANSPORATION

(71) Applicant: BNSF Railway Company, Fort Worth, TX (US)

(72) Inventors: Christian Isaacs, Topeka, KS (US); Michael Vierling, Topeka, KS (US)

(21) Appl. No.: 16/177,124

(22) Filed: Oct. 31, 2018

Related U.S. Application Data
(60) Provisional application No. 62/579,660, filed on Oct. 31, 2017.

(51) Int. Cl. G06Q 30/08; G06Q 10/02; G06Q 50/30

(52) U.S. Cl. CPC G06Q 30/08; G06Q 50/30; G06Q 10/02

(57) ABSTRACT

An apparatus, a method, and a non-transitory computer readable medium provide for managing COTs. The method includes initiating, by an admin terminal of the plurality of user terminals, a COT auction for a COT received from an admin terminal; placing, by a first customer terminal of the plurality of user terminals, a first bid in the COT auction; placing, by a second customer terminal of the plurality of user terminals, a second bid in the COT auction; determining, by the COT processing system, a winner of the COT auction between the first bid and the second bid using the winner determination logic; and issuing, by the COT processing system, the COT according to the determined winner.

### CROSS-REFERENCE TO RELATED APPLICATION

The present application claims the benefit of U.S. Provisional Patent Application Ser. No. 62/579,660, filed Oct. 31, 2017, which is incorporated herein by reference for all purposes.

### TECHNICAL FIELD

The present invention relates in general to railroad operations, and in particular, to systems and methods for managing certificates of transportation.

### BACKGROUND

A Certificate of Transportation (COT) represents one or more grain cars that a railroad sells to its customers through an auction. COTs are classified into seven different types depending on the commodity, redeem period, price, and car amount. Generally, the type of COT determines how many cars it is worth. A COT also has restrictions on when it can be used (specific month/year and period in the month, first, middle, or last).

In auctioning COTs, at least two significant challenges are presented. The first challenge is to determine how many of the COTs requested are won. For example, each COT could be treated individually instead of as a group, each bidder could be allowed to only win the exact number of COTs requested, or each bidder could be allowed to win less than the number of COTs requested. The second challenge is to determine what amount each bidder is paying for a COT. For example, determinations must be made as to when to account for increment and when to account for bid time, what the priorities for increment and bid time should be, and how to handle proxy bidding.

### SUMMARY

The principles of the present invention are embodied in systems and methods for managing Certificates of Transportation (COTs). In particular, systems and methods are disclosed for managing the auction of COTs using open (proxy) auctioning, which remove over-bidding in blind auctions and drive shuttle and non-shuttle premium values to lower levels.

In one example embodiment, a system provides for managing COTs. The system includes a plurality of user terminals, a network, and a COT processing system. The plurality of user terminals each including a display screen for presenting a graphical user interface and output information. The network communicating with the plurality of user terminals. The COT processing system communicating with the plurality of user terminals and operable to perform winner determination logic. The plurality of terminals includes an admin terminal that initiates a COT auction for a COT; a first customer terminal that places a first bid in the COT auction; and a second customer terminal that places a second bid in the COT auction. The COT processing system determines a winner of the COT auction between the first bid and the second bid using the winner determination logic, and issues the COT according to the determined winner.

In another example embodiment, a method provides for managing COTs. The method includes initiating, by an admin terminal of the plurality of user terminals, a COT auction for a COT received from an admin terminal; placing, by a first customer terminal of the plurality of user terminals, a first bid in the COT auction; placing, by a second customer terminal of the plurality of user terminals, a second bid in the COT auction; determining, by the COT processing system, a winner of the COT auction between the first bid and the second bid using the winner determination logic; and issuing, by the COT processing system, the COT according to the determined winner

In another example embodiment, a non-transitory computer readable medium provides for managing COTs. The non-transitory computer-readable medium storing instructions that, when executed, causes a processor to initiate, by an admin terminal, a COT auction for a COT received from an admin terminal; place, by a first customer terminal, a first bid in the COT auction; place, by a second customer terminal, a second bid in the COT auction; determine, by a COT processing system, a winner of the COT auction between the first bid and the second bid using winner determination logic; and issue, by the COT processing system, the COT according to the determined winner.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high-level block diagram of a representative system for managing certificates of transportation according to the principles of the present invention;

FIG. 2 is a flow diagram of a representative method for managing certificates of transportation according to the principles of the present invention;

FIGS. 3A-3V are diagrams of an administrative portal graphical user interface according to a representative embodiment of the present principles;

FIGS. 4A-4O are diagrams of a customer port graphical user interface according to a representative embodiment of the present principles; and

FIG. 5 illustrates an exemplary high level functional block diagram illustrating a representative computer network operating environment in which the principles of the present invention can advantageously be applied.

### DETAILED DESCRIPTION

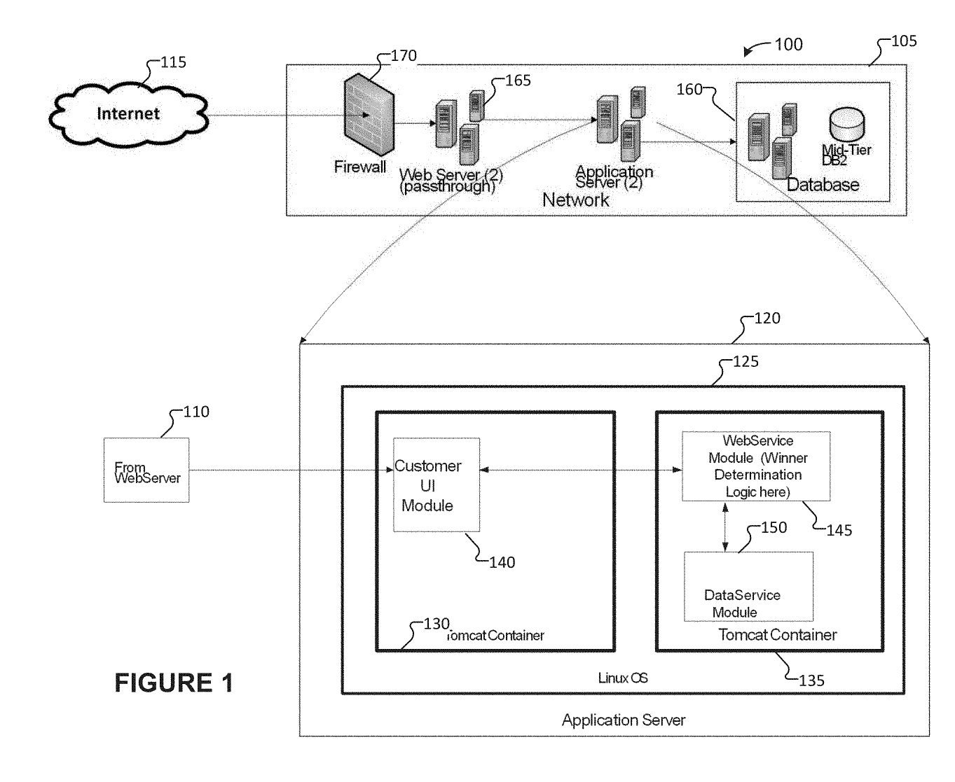

FIGS. 1 through 5, discussed below, and the various embodiments used to describe the principles of the present disclosure in this patent document are by way of illustration only and should not be construed in any way to limit the scope of the present disclosure. Those skilled in the art can understand that the principles of the present disclosure may be implemented in any type of suitably-arranged device or system.

FIG. 1 is a high-level block diagram of a representative system 100 for managing certificates of transportation (COTs) according to the principles of the present invention. The embodiment of the COTs system 100 is illustration only. FIG. 1 does not limit the scope of this disclosure to any particular implementation of a COTs system.

The COTs system 100 provides for managing COTs. The system 100 includes of a network 105, a user webserver 110, and the Internet 115. The network 105 includes the application server 120, a database 160, a web server 165 and a firewall 170. The application server 120 includes a customer container 130 and a client container 135. The customer container 130 includes a customer user interface (UI) module 140 and the client container 135 includes a webservice module 145 and a data service module 150.

The winner determination logic is executed on the application server 120, which could be a Linux-based server with a processor. There are two matching application servers 120 used in the production environment, set up to load balance all requests. Each server 120 houses two containers 130 and 135, a customer container 130 for the customer UI and a client container 135 for everything else, including the winner determination logic.

The COTs application consists of multiple WAR files (modules) that are deployed to a Tomcat container. For example, the COTS application has eight modules. The winner determination logic runs in the webservice module 145 and stores its results in the dataservice module 150. The results of the winner determination process are housed in a database 160, such as a mid-tier DB2 database.

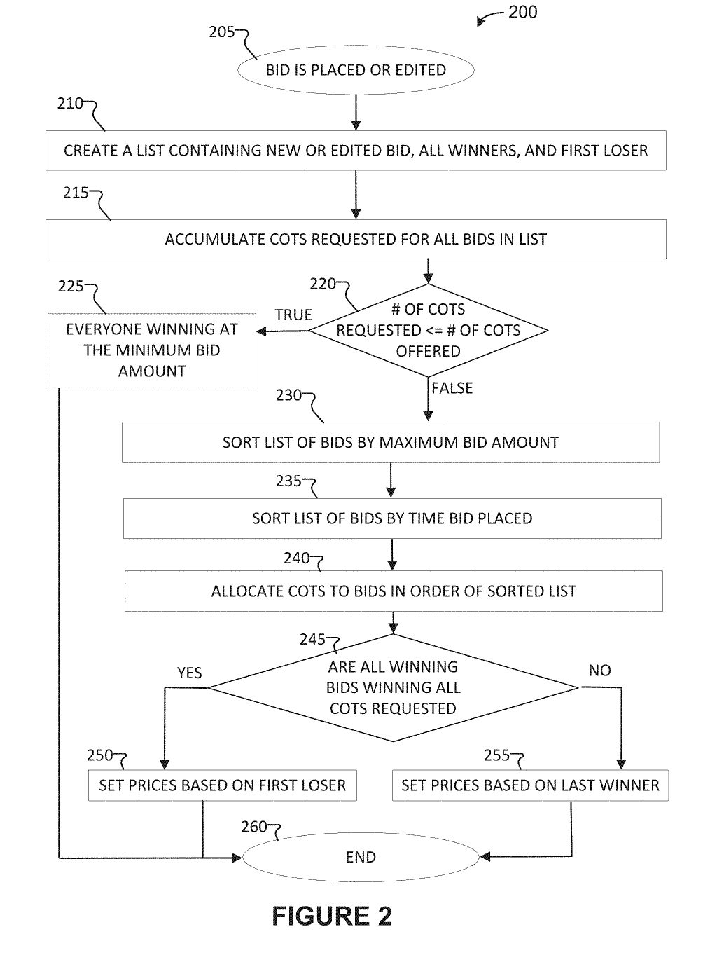

FIG. 2 is a flow diagram of a representative method for managing certificates of transportation according to the principles of the present invention. The embodiment of the NoSQL storage 1400 is illustration only. FIG. 14 does not limit the scope of this disclosure to any particular implementation of a NoSQL storage.

In operation 205, the COTs system 100 receives a bid or a bid is edited. A user or customer can find a COTs to bid that is open and place a new or edited bid.

In operation 210, the COTs system 100 creates a list containing all new or edited bids, all winners and a first loser. The list can be created once the bid is placed or once a COTs action time has ended. The list can also be updated upon the entering of a new bid or an edited bid. The list can include all of the new or edited bids, all the winning bids, and a first loser bid.

In operation 215, the COTs system 100 accumulates COTs requested for all bids in list. Each bidder can request COTs through the bidding process.

In operation 220, the COTs system 100 determines if the number of COTs requested by the all of the bidders is less than or equal to the number of COTs offered. If the number of COTs requested is less than or equal to the number of COTs offered, the process proceeds with operation 225. If the number of COTs requested in more than the number of COTS offered, the process proceeds to operation 230.

In operation 225, the COTs system 100 selects the minimum bid placed by every bid as the winning bid for the request COTs. Once all of the winners are notified, the process proceeds to operation 260.

In operation 230, the COTs system 100 sorts the list of bids by the maximum bid amount. The customers are sorted based on a maximum bid stance to determine a first loser. The list is ordered based on the maximum amount a user or customer is willing to bid on a COT.

In operation 235, the COTs system 100 performs a secondary sort of the list of bids based on a time the bid was placed. The customers are sorted based on time a bid is entered to determine the winner between two maximum bids that are equal.

In operation 240, the COTs system 100 allocates COTs to bids in order of the sorted list. Before the specific price is set, the winners of the COTs are determined. A threshold minimum bid amount could be used to filter out customers with maximum bids less than a minimum bid amount for a specific COT.

In operation 245, the COTs system 100 determines whether all the COTs requested have a corresponding winning bid. When all the COTs request correspond to winning bids, the process proceeds to operation 250. When COTs are not request or do not have corresponding winning bids, the process proceeds to operation 255.

In operation 250, the COTs system 100 sets the prices based on a first loser. The amount bid for each winning bidder equals the bid before the first loser. The next winning bid amount is equal to the first loser's maximum bid or the overall minimum bid amount, whichever is higher. The winning bids are equal to the loser's maximum when the winning bid is placed before the loser's bid. When the loser's bid occurs before the winner's bid, the winner bid is the maximum of the loser's bid plus a bid increment or the threshold minimum bid. When the bid increment is used, the winner's bid is not to be more than the winner's maximum bid.

In operation 255, the COTs system 100 sets the prices based on a last winner. For all bids placed before the last winner, the bid is the last winner's maximum or the overall bid amount, whichever is higher. For all bids placed after the last winner, the amount of the bid at the last winner's maximum bid plus a bid increment or the overall minimum bid, whichever is higher. When the bid increment is used, the winner's bid is not to be more than the winner's maximum bid.

In operation 260, the COTs system 100 has issued all the COTs at the prices determined based on operations 250 or 255. Table 1-3 provide examples of the bidding on COTs offered.

TABLE 1

| | | COTs | | | | |
|---|---|---|---|---|---|---|
| Bidder | | Requested | | | | |
| Company | | COTs | Bid | Starting Bid | | |
| Bidder Name | Status | Winning | Amount | Maximum Bid | Total Bid | BidTime |
| Company A | Won | 2 | $6,000 | $0 | $12,000 | 12:15:07 PM |
| 1^{st} Bidder | | 2 | | $100,000 | | |
| Company B | Lost | 2 | $0 | $3,000 | $0 | 12:26:33 PM |
| 6^{th} Bidder | | 0 | | $5,000 | | |
| Company C | Lost | 2 | $0 | $3,000 | $0 | 12:24:21 PM |
| 5^{th} Bidder | | 0 | | $6,000 | | |
| Company D | Lost | 2 | $0 | $1 | $0 | 12:21:24 PM |
| 4^{th} Bidder | | 0 | | $3,000 | | |
| Company E | Lost | 2 | $0 | $0 | $0 | 12:19:37 PM |
| 3^{rd} Bidder | | 0 | | $1 | | |
| Company F | Lost | 2 | $0 | $0 | $0 | 12:18:02 PM |
| 2^{nd} Bidder | | 0 | | | | |

In table 1, two COTs are being offered for bidding. Companies A-F are each requesting and bidding on two COTS. Because the bid for company A was the first bidder, the amount of the bid only matches the successive bids until a later bidder bids over the first bidder's maximum amount. In this case, company A has a maximum bid of $100,000. For a later bidder to win the request COTs, a bid of over $100,000 would need to be placed.

The fifth bidder bids a maximum of $6,000 at a time after the first bidder. Once this bid comes in, the winning bidders before this bid was placed would have to match the $6,000. In other words, the winning bid for Company A would be $6,000. All of the other companies had bids lower than $6,000 would not be considered further in the bidding process. Company B places a bid after Company C, but the maximum bid is only $5,000. Because Company B's maximum bid is less than the winning bid, Company B's bids are out of contention.

In the end, Company A wins the request COTs at a bid amount of $6,000.

TABLE #2

| | | COTs | | | | |
|---|---|---|---|---|---|---|
| Bidder | | Requested | | | | |
| Company | | COTs | Bid | Starting Bid | | |
| Bidder Name | Status | Winning | Amount | Maximum Bid | Total Bid | BidTime |
| Company A | Won | 4 | $21,001 | $21,000 | $84,004 | 2:47:19 PM |
| 3^{rd} Bidder | | 4 | | $21,500 | | |
| Company B | Won | 4 | $21,000 | $20,800 | $21,000 | 2:37:01 PM |
| 1^{st} Bidder | | 1 | | $21,000 | | |
| Company C | Lost | 4 | $0 | $20,800 | $0 | 2:46:43 PM |
| 2^{nd} Bidder | | 0 | | $21,000 | | |

In Table #2, Companies A-C are bidding on five COTs offered. Company B is the first bidder in this example. Company B is the first bidder and places a starting bid at $20,800 and a maximum bid at $21,000 for four COTs. Company C is the second bidder and places a starting bid at $20,800 and a maximum bid of $21,000 for four COTs. Companies B and C bid's match, but Company B was placed before Company C. Company A's is the third bidder and places a starting bid at $21,000 and a maximum bid at $21,500 for four COTs.

Company A bidder must exceed the maximum bid of the other bidder by $1 to win because the bid was placed last. Company B's bid was increased to a maximum when the third bid was placed. Company B and Company C are tied, but Company B wins the remaining COT because the bid was placed first. Company C's bid was increased up to the maximum by the bids from Company A. A tie is won by the earlier bid time, which means that Company B is the winner of the remaining COT that company A did not bid on.

TABLE #3

| | | COTs | | | | |
|---|---|---|---|---|---|---|
| Bidder | | Requested | | | | |
| Company | | COTs | Bid | Starting Bid | | |
| Bidder Name | Status | Winning | Amount | Maximum Bid | Total Bid | BidTime |
| Company A | Won | 1 | $20,800 | $20,800 | $20,800 | 3:47:32 AM |
| 1^{st} Bidder | | 1 | | $20,800 | | |
| Company B | Lost | 1 | $0 | $20,800 | $0 | 3:58:47 AM |
| 2^{nd} Bidder | | 0 | | $20,800 | | |

In Table #3, Companies A and B are bidding on one COT offered. Company A is the first bidder and places a starting bid at $20,800 and a maximum bid at $20,800. Company B is the second bidder and also places a starting bid at $20,800 and a maximum bid at $20,800. Because the maximum amounts of the bids for Company A and Company B are the same, the winner is chosen based on the time of the bid. Company A is the first bidder and is therefore awarded the winning bid.

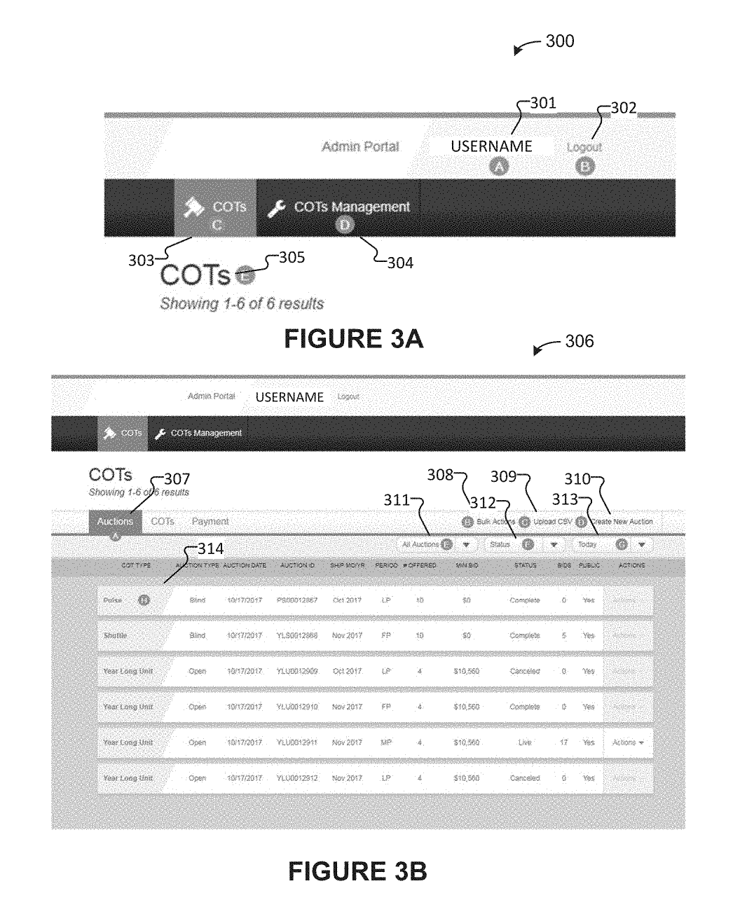

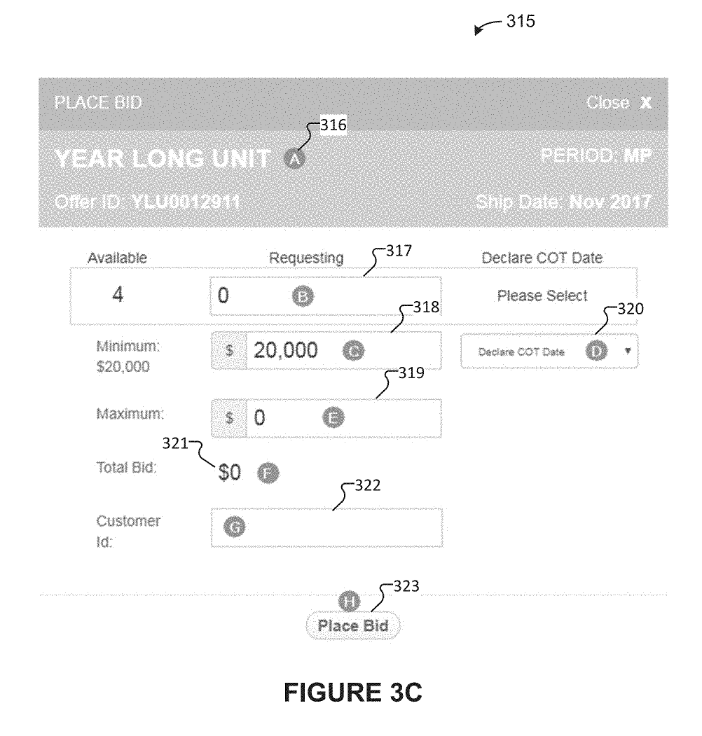

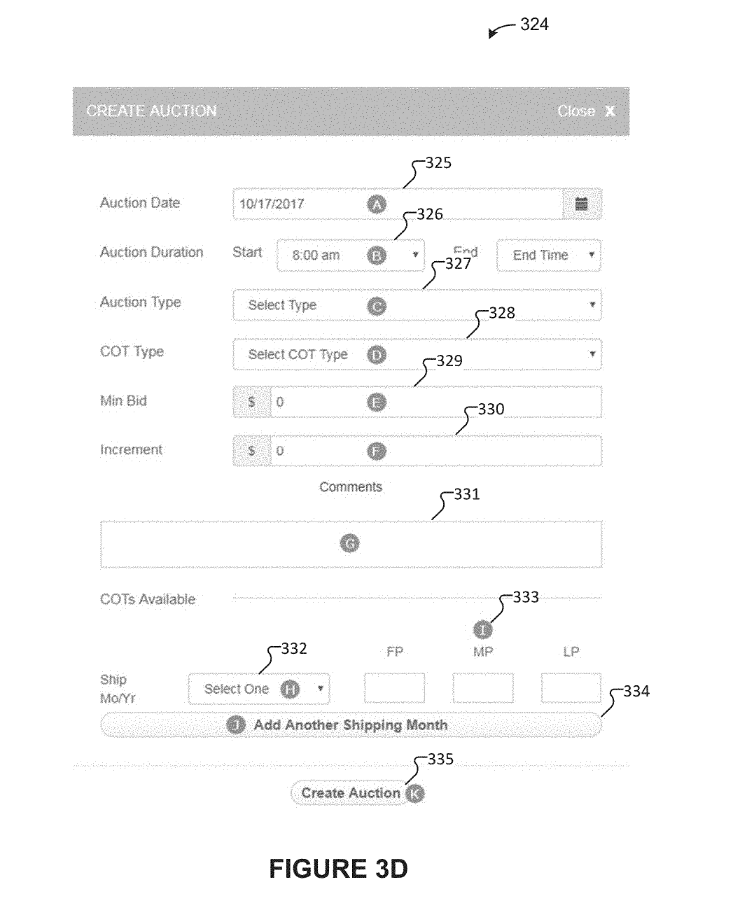

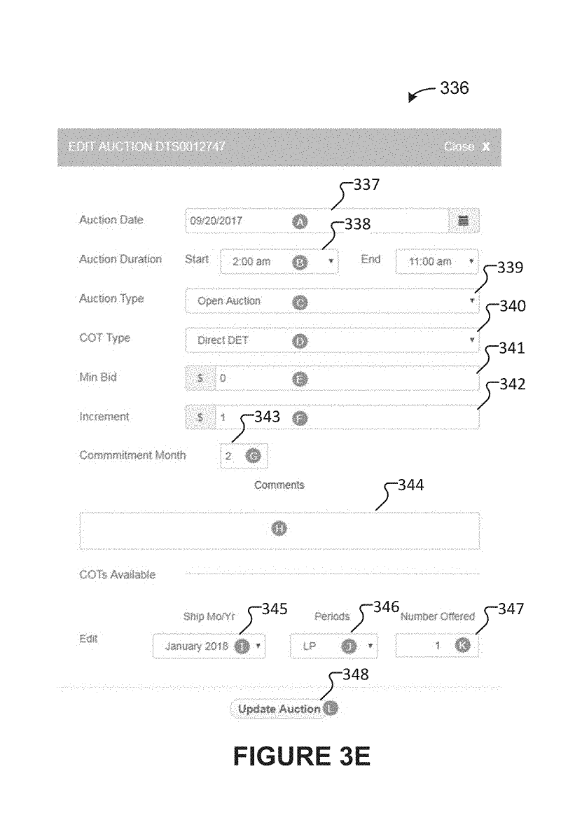

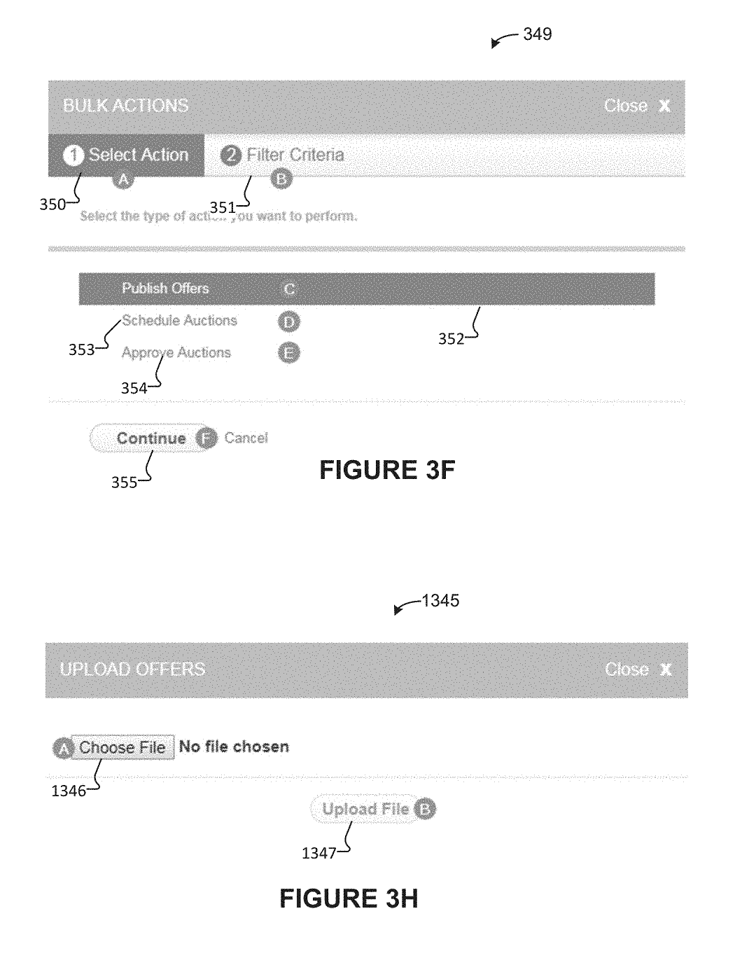

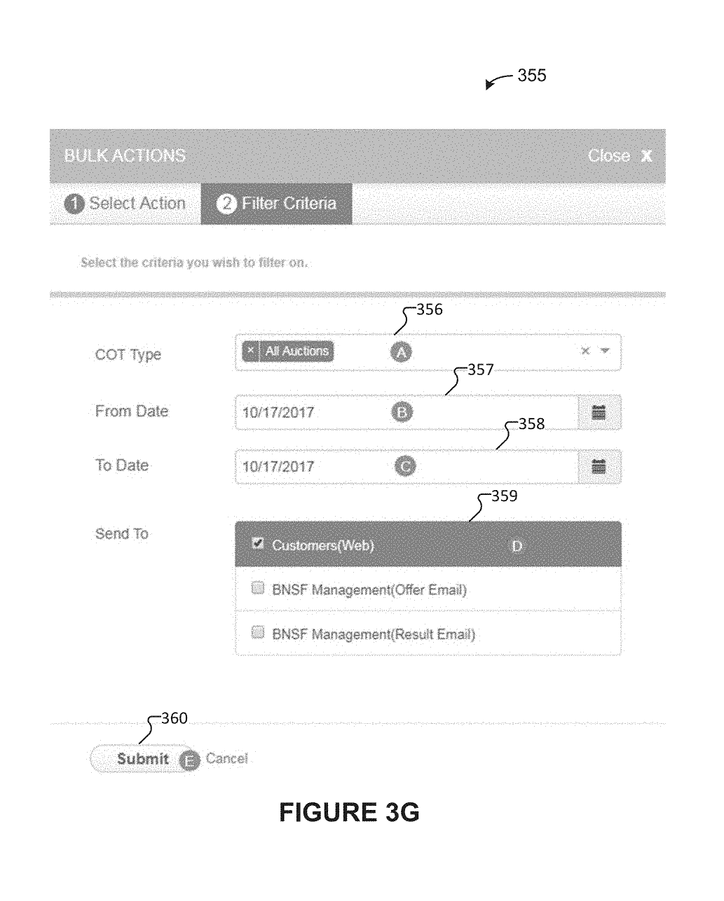

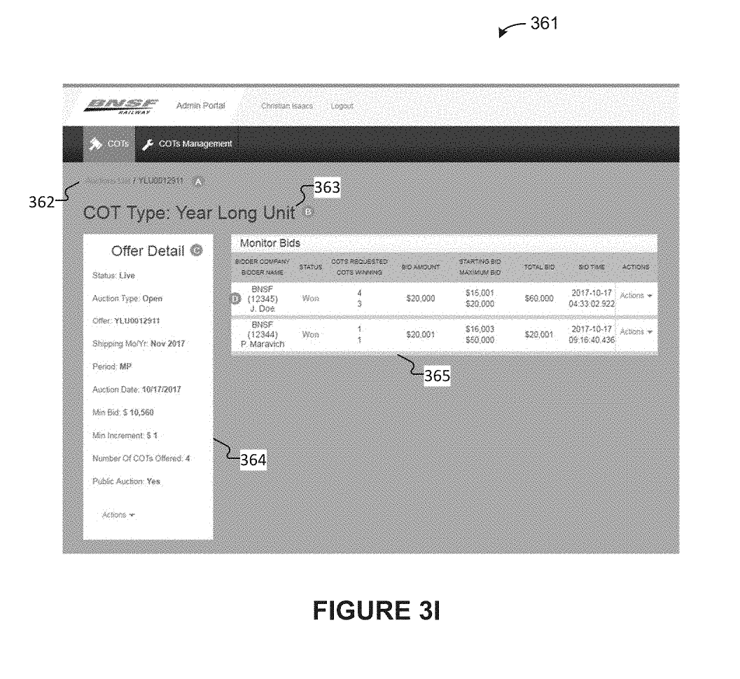

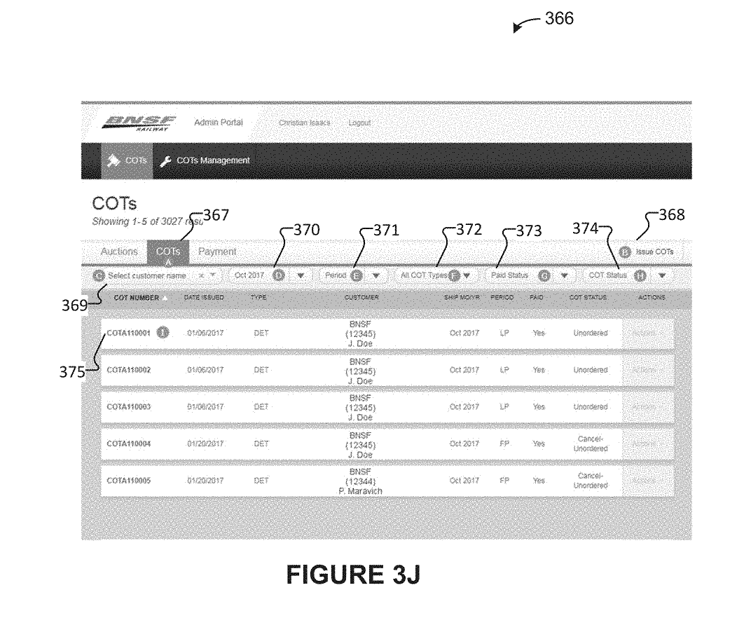

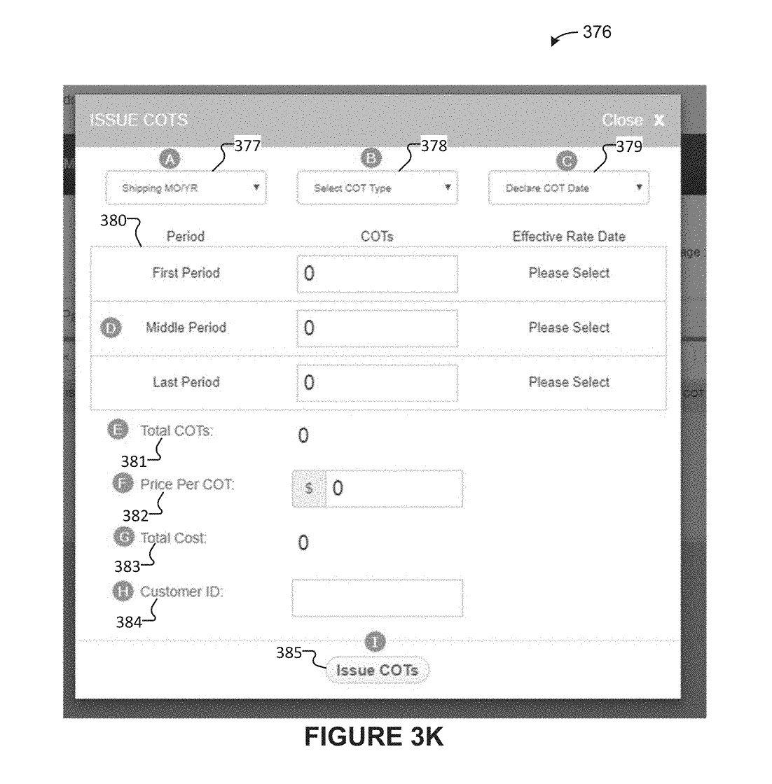

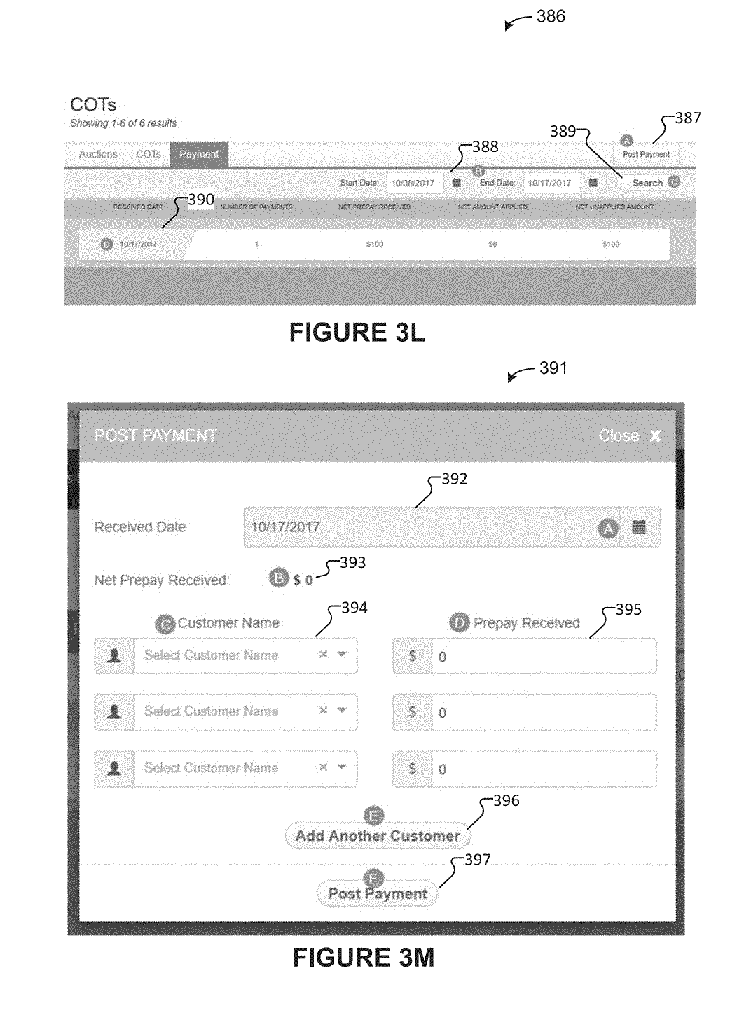

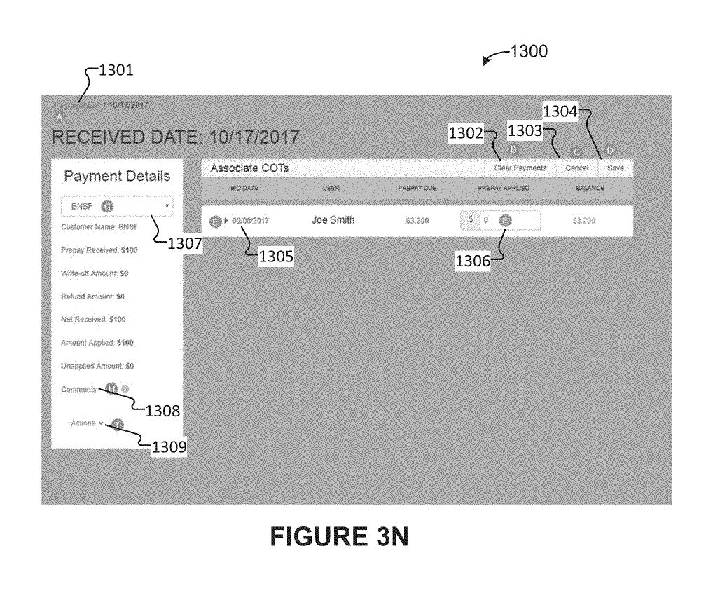

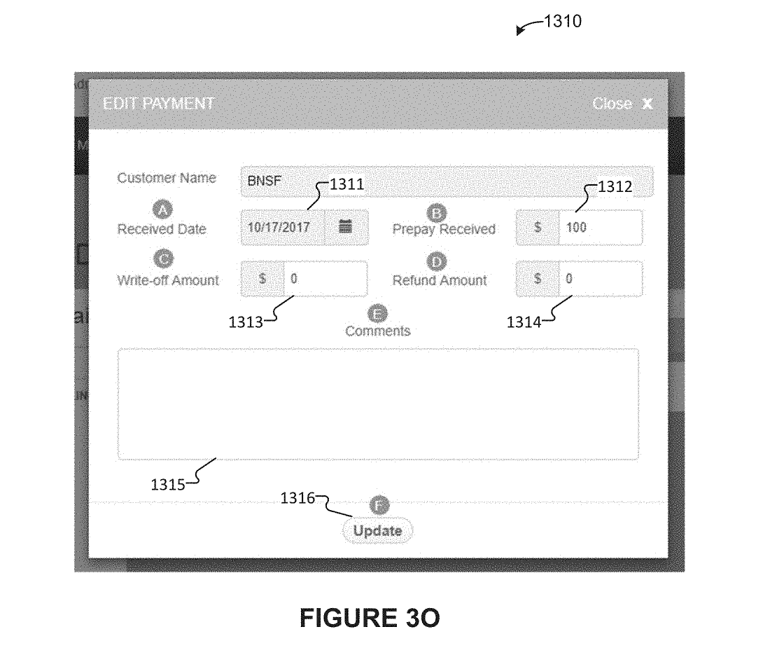

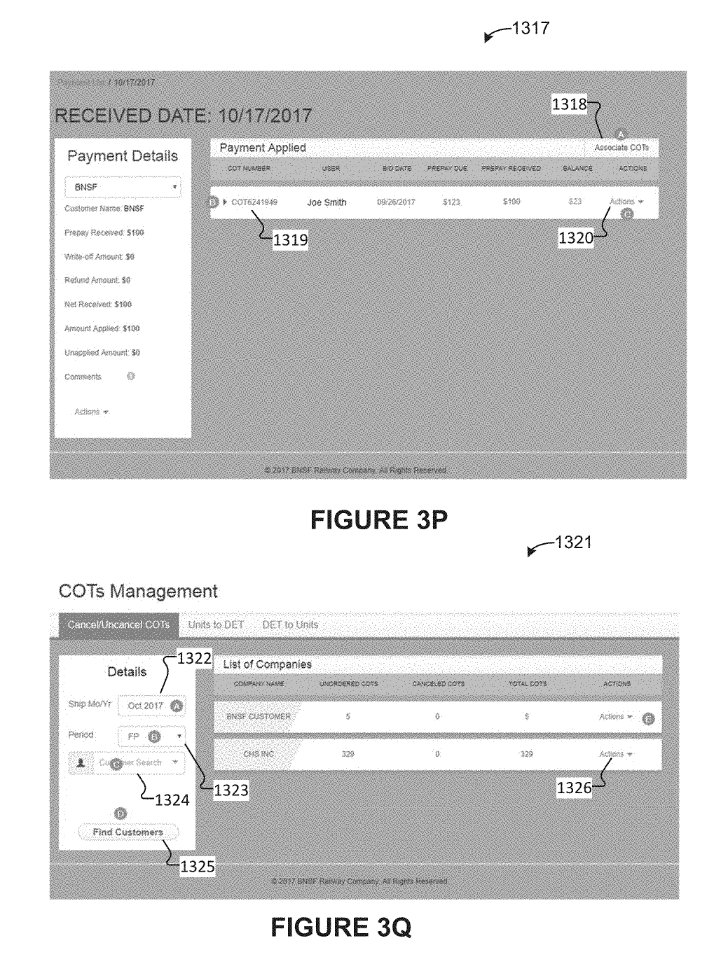

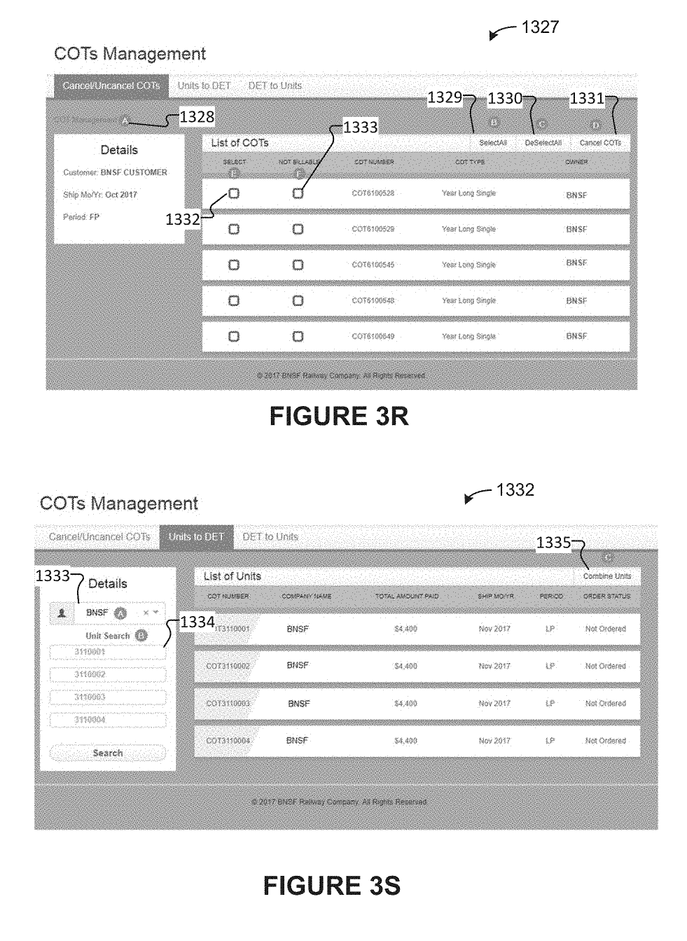

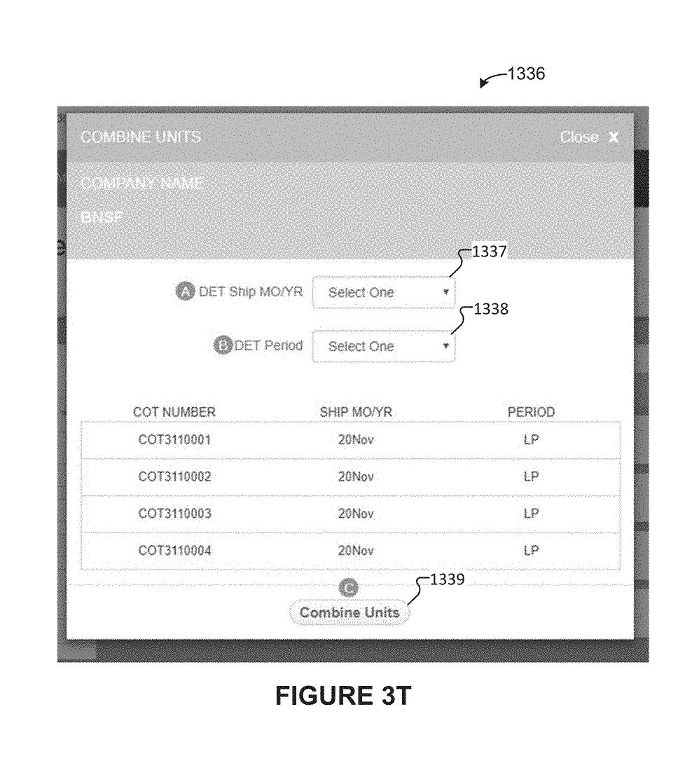

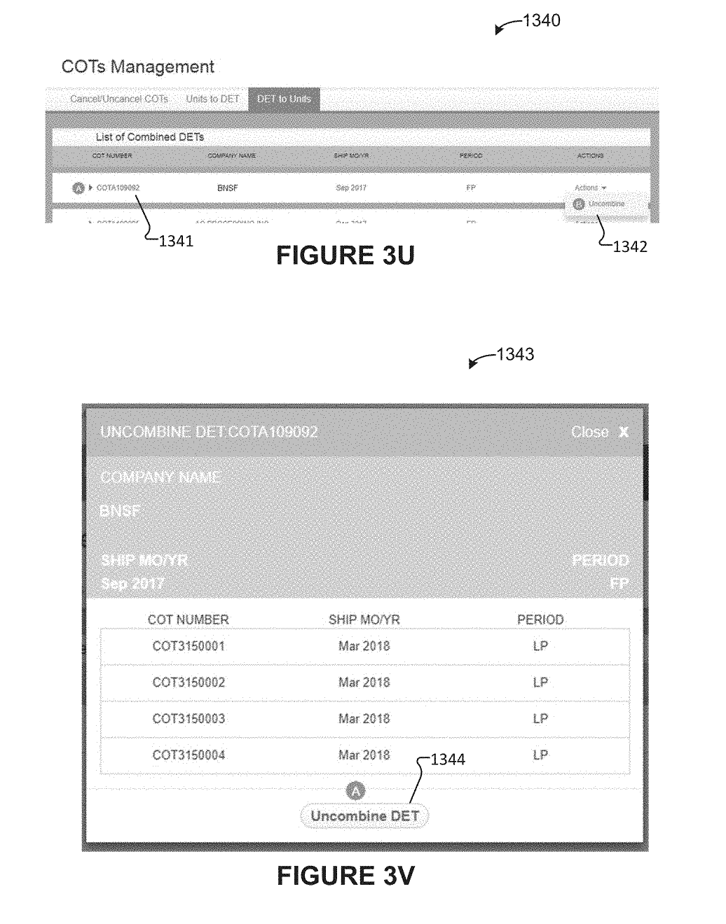

FIGS. 3A-3V are diagrams of an administrative portal graphical user interface 300 according to a representative embodiment of the present principles. The embodiment of the administrative portal graphical user interface 300 is illustration only. FIG. 14 does not limit the scope of this disclosure to any particular implementation of an administrative portal graphical user interface.

The COTS admin portal UI 300 includes a user identification (ID) 301, a user logout 302, a high-level section 303 of the application, a currently-selected section 304, and a results overview 305. The user ID 301 identifies a user that is logged into the admin portal UI 300. The user logout 302 allows the logged in user to log out of the admin portal UI 300. The high-level section 303 of the admin portal UI 300 provides a list of the different sections that are accessible by the admin portal UI 300. The currently-selected section 304 displays the current section that has been access by the user. The results overview 305 provides results of the currently-selected section 304.

FIG. 3B illustrates an exemplary auction list 306 of the auctions tab 307 according to embodiments of the present disclosure. The auction list 306 includes bulk actions input 308, an upload file input 309, a create new auction input 310, an auction filter 311, a status filter 312, a time filter 313, and at least one auction card 314. The auction tab 307 is a sub-section tab that is currently selected and the currently selected tab is highlighted. The bulk actions input 308 opens a modal allowing an admin to publish, schedule or approve multiple actions at once. The upload file input 309 opens a modal allowing the admin to upload multiple auctions. For example, the auctions could be uploaded using a CVS file. The create new auction input 310 opens a modal allowing the admin to create an upcoming or future auction. The auction filter 311 is used to narrow down or filter data to a specific COT type. The status filter 312 is used to narrow down or filter data to a specific auction status. The time filter 313 is used to narrow down or filter data to a specific time frame.

The at least one auction card 314 includes a COT type, an auction type, an auction date, an auction ID, a shipping year and shipping month, a period, a number of COTs offered, an overall minimum bid, an auction status, a number of bids, a public indicator, and an action list. The COT type is the type of COT being auctioned. The COT type is selected and opens a detail page with greater details regarding the COT and COT type. The auction type is the type of auction of the COT, which could include open auction, blind auction, etc. The auction ID is a unique ID for identifying the auctions. The shipping year and month are the year and month that the COT is active for or the starting month for COTs with longer commitments. The period is one of three periods, being first, middle or last. The period specifies when in the month the COT can be used. The number of COTs offered is the number of COTs offered in a specific auction. The overall minimum bid is the lowest bid that is accepted as a bid for a specific COT. All maximum bids less than the overall minimum bid are discarded or ignored. The auction status is the status of the auction, including open, pending, closed, etc. The number of bids is the current number of bid in the auction on a specific COT. The public indicator is used to show whether the auction has been made public for bidding or if it is tied to an issued COT auction.

The actions list can include a number of actions that the user or admin can take on the auction depending on the current state. When the current auction is pending review, the action list includes an edit action to open a modal to edit all auction option prior to scheduling, a cancel action used to cancel an offer, and a schedule action to move the state of the auction to schedule in order to go live when the auction start time occurs. When the current auction is scheduled, the action list includes an edit action that opens a modal to edit specifics of the auction, and a cancel action used to cancel an offered COT. When the current auction is live, the action list includes an extend schedule action that opens a modal to make the auction last longer, and a create bid action that opens a modal allowing the admin to bid on behalf of a customer. When the current auction is closed, the action list includes an approve results action that allows approval of the auction to trigger notification to the bidders of the respective outcomes and displaying the results on the customer portal. When the current auction is completed or canceled, the action list does not provide any option to the user or admin.

FIG. 3C illustrates an exemplary place bid modal 315 according to the embodiments of the present disclosure. The place bid modal 315 includes a COT type 316, a numbering request 317, a minimum bid 318, a maximum bid 319, a declared COT date 320, a total bid 321, a customer ID 322, and a place bid button 323. The COT type 316 is the Cot type that the bid is being placed on. The numbering request 317 is a user input for how many COTs the user want to place a bid on. The minimum bid 318 a user input for the minimum starting price for the bid of the COTs. This field has to start at the current auction floor. The maximum bid 319 is a user input for the highest price the user is willing to pay for each COT. The declared COT date 320 is a user input from a menu. The COT date 320 relates to the billing rate to use for the COTs if the user is a winner. The date selected can either be the date that the bid is placed or the first day the COT is eligible to be used. The options are displayed based on the COT type being offered in the auction. The total bid 321 is a calculation of the requesting times by the maximum bid 319 The result is the most that the user would have to pay if all COTs were won at the maximum amount. The customer ID 322 is a user input to select a customer ID they are bidding on behalf of. The place bid button 323 clickable button to submit the bid.

FIG. 3D illustrates an exemplary create new auction modal 324 according to the embodiments of the present disclosure. The new auction modal 324 includes an auction date 325, an auction duration input 326, an auction type input 327, a COT type input 328, an overall minimum bid input 329, a bid increment 330, a comments box 331, a shipping month and year selection 332, a COT period 333, an add shipping month button 334, and a create auction button 335. The auction date 325 is a user input to select the date the auction will take place. The auction duration input 326 is a user input to set the start time and end time for the auction. The auction type input 327 is a user input to select the open auction or closed auction type. The COT type input 328 is a user input to select the type of COT that is to be auctioned. The overall minimum bid input 329 is a user input to select the smallest amount a user can enter to be a valid initial bid. The bid increment 330 is a user input to select an amount a bid must be above another bid to be winning. The comments box 331 is a user input for the admin to include additional details to the customers. The shipping month and year selection 332 is a user input to select which year and month the COT is active for or a starting month for COTS with longer commitments. The COT period 333 is the first, middle and last period entry boxes to enter how many will be offered in the specific auction. The COT period specifies when in the month that the COT can be used. The add shipping month button 334 is a button to add additional rows for a different shipping month and year used to create multiple auctions with the same information and different shipping month and year. The create auction button 335 puts the auction in the pending review state for the admin to schedule after review.

FIG. 3E illustrates an exemplary edit auction modal 336 according to the embodiments of the present disclosure. The edit auction modal 336 includes an edit auction date 337, an edit auction duration 338, an edit auction type 339, an edit COT type 340, an edit minimum bid 341, an edit increment bid 342, an edit commitment month 343, an edit comments box 344, an edit shipping month and year 345, an edit period 346, an edit number COTs offered 347, and a update auction button 348. The edit auction date 337 is a user input to edit or update the date the auction will take place. The edit auction duration input 338 is a user input to edit or update the start time and end time for the auction. The edit auction type input 339 is a user input to edit or update the open auction or closed auction type. The edit COT type input 340 is a user input to edit or update the type of COT that is to be auctioned. The edit overall minimum bid input 341 is a user input to select the smallest amount a user can enter to be a valid initial bid. The edit bid increment 342 is a user input to select an amount a bid must be above another bid to be winning. The edit comments box 344 is a user input for the admin to include additional details to the customers. The edit shipping month and year selection 345 is a user input to select which year and month the COT is active for or a starting month for COTS with longer commitments. The edit COT period 346 is the first, middle and last period entry boxes to enter how many will be offered in the specific auction. The edit COT period 346 specifies when in the month that the COT can be used. The edit number offered 347 is a user input to set how many of the COT type will be offered for that shipping month and year and period. The update auction button 348 applies any changes made to the auction.

FIGS. 3F and 3G illustrate a select action tab 350 for a bulk actions modal 349 and a filter criteria tab 351 for a bulks action modal 355 according to embodiments of the present disclosure. The bulk action modal 349 and the bulk action modal 355 illustrate different tabs for an exemplary bulk action modal. The select action tab 350 is a header for the first step of a bulk action used to pick which action to perform. The select action tab 350 includes a publish offers action 353, a schedule auctions action 354, an approve auction action 355, and a continue button 355. The publish offers action 353 is an action that sends the offers to the customers. The schedule auctions action 354 is an action to change the pending reviewed auction to schedule. The approve auction action 355 is an action to approve the result of an auction. The continue button 355 is a button to move to the filter criteria tab 351.

The filter criteria tab includes a COT type input 356, a from date input 357, a to date input 358, a send to input 359, and a submit button 360. The COT type input 356 is a user input to pick which COT types to apply an action to. The from date input 357 is a user input to select the first date of a range to perform the action from the select action tab 350. The to date input 358 is a user input to select the second date of a range to perform the action from the select action tab 350. The send to input 359 selects which locations to send the offers to. The submit button 360 performs the action with the specified filter criteria from the bulk actions modal 349.

FIG. 3H illustrates an upload offers modal 1345 according to embodiments of the present disclosure. The uploads offers modal 1345 includes a choose file button 1346 and a upload file button 1347. The choose file button 1346 is a button that takes the admin to a storage explorer to find the file to be uploaded. The upload file button 1347 is a button to upload the selected file and create cards for each auction.

FIG. 3I illustrate an exemplary admin detail screen 361 according to embodiments of the present disclosure. The admin detail screen 361 includes an auction list link 362, a COT type title 363, an offer detail panel 364, and at least one bid card 365. The auction list link 362 is a link that takes the user back to the auction list with the auction ID associated with the details shown. The COT type title 363 shows the COT type associated with the auction ID details being viewed. The offer detail panel 364 includes the following information including an auction status, an auction type, an auction offer, an auction shipping month and year, a COT period, an auction date, a minimum bid, a minimum increment, a number of COTs offered, a public indicator and an actions list. The auction status shows the current state of the auction. The auction type is the type of auction of the COT, which could include open auction, blind auction, etc. The auction offer is a unique ID for identifying the auctions. The shipping year and month are the year and month that the COT is active for or the starting month for COTs with longer commitments. The period is one of three periods, being first, middle or last. The period specifies when in the month the COT can be used. The number of COTs offered is the number of COTs offered in a specific auction. The overall minimum bid is the lowest bid that is accepted as a bid for a specific COT. All maximum bids less than the overall minimum bid are discarded or ignored. The auction status is the status of the auction, including open, pending, closed, etc. The number of bids is the current number of bid in the auction on a specific COT. The public indicator is used to show whether the auction has been made public for bidding or if it is tied to an issued COT auction.

The actions list can include a number of actions that the user or admin can take on the auction depending on the current state. When the current auction is pending review, the action list includes an edit action to open a modal to edit all auction option prior to scheduling, a cancel action used to cancel an offer, and a schedule action to move the state of the auction to schedule in order to go live when the auction start time occurs. When the current auction is scheduled, the action list includes an edit action that opens a modal to edit specifics of the auction, and a cancel action used to cancel an offered COT. When the current auction is live, the action list includes an extend schedule action that opens a modal to make the auction last longer, and a create bid action that opens a modal allowing the admin to bid on behalf of a customer. When the current auction is closed, the action list includes an approve results action that allows approval of the auction to trigger notification to the bidders of the respective outcomes and displaying the results on the customer portal.

The least one bid card 365 includes a bidder company or bidder name, a bid status, a COTs requested, a COTs winning, a current bid amount, a starting bid amount, a maximum bid amount, a total bid, a bid time and an action tab. The bidder company or bidder name is the company or bidder associated with placing the bids in the specific bid card. The bid status shows the current status of the bid to see if card is winning. The COTs requested shows how many COTs the bidder wanted to win when placing the bid. The COTs winning shows how many COTs the bidder is currently winning. The current bid amount shows the current amount the bid is at. The starting bid amount shows the lower end of the range the bidder is willing to bid to win. The maximum bid amount is the higher end of the range the bidder is willing to bid to win. A total bid calculates the number of COTs winning multiplied by the current bid amount. The bid time shows the exact timestamp that the user placed the bid for breaking ties of bid amount. The action tab provides actions that an admin can take on an auction dependent on the current state including an edit action that opens a modal to edit a bid on behalf of the customer and a cancel modal to cancel a blind bid on behalf of a customer.

FIG. 3J illustrates a COTs list 366 according to embodiments of the present disclosure. The COTs list 366 is illustrated with a COTs sub-section 367 highlighted. The COTs list includes an issued COTs button 368, a list customer name input 369, a list shipping month and year filter 370, a list period filter 371, a list COT type filter 372, a list paid status filter 373, a COT status filter 374, and at least one list card 375. The issued COTs button 368 opens a modal to issue COTs outside of an auction. The list customer name input 369 is an input used to filter results based on the customer name. A list shipping month and year filter 370 is an input used to filter the list cards 375 based on the shipping month and year. The list period filter 371 is an input used to filter the list cards 375 based on the shipping period. The list COT type filter 372 is an input used to filter the list cards 375 based on the type of COT. The list paid status filter 373 is an input used to filter the list cards 375 based on whether the bid is paid or not. The COT status filter 374 is an input used to filter the list cards 375 based on the current status of the COT.

The least one list card 375 includes a COT number, a date issued, a COT type, a customer, a shipping month and year, a period, a paid status, an auction status, and an action list. The COT number is a unique ID used to reference a COT. The date issued is a date the COT was issued to the customer. The COT type is the type of the COT associated with the COT number. The customer is the company or bidder who owns the COT. The shipping month and year is the year and month the COT is active for or the starting month for COTs with longer commitments. The period is one of three periods, including a first, middle, or last. The period specifies when in the month the COT can be used. The paid status shows whether or not the COT has been paid for. The auction status shows the current state of the auction. The action list currently does not provide action to perform on this screen.

FIG. 3K illustrates an issue COTs tab 376 according to embodiments of the present disclosure. The issue COTS tab 376 includes an issue shipping month and year dropdown 377, an issue COT type dropdown 378, an issue declare COT date dropdown 379, an issue period input 380, an issue total COTs 381, an issue price per COT input 382, an issue total cost 383, an issue customer ID input 384, and an issue COTs button 385. The issue shipping month and year dropdown 377 is a dropdown menu for a user input to select a month and year of COTs to be created. The issue COT type dropdown 378 is a dropdown menu for a user input to select a COT type of COTs to be created. The issue declare COT date dropdown 379 is a dropdown menu for a user input to select a rating date for COTs to be created and selecting a date will replace “please select” with the date. The issue period input 380 is a user input for a number of COTs to create for the specified period for one of a first period, a middle period, and a last period. The issue total COTs 381 is a label field that is the sum of the user input for the first period, the middle period, and the last period inputs. The issue price per COT input 382 is a user input that is the price of each COT being created. The issue total cost 383 is a label field that is the product of the total COTs and the price per COT. The issue customer ID input 384 is a customer ID in which the COTs to be created will belong to. The issue COTs button 385 is a clickable button that can created the COTs based on the user input.

FIG. 3L illustrates an exemplary payment list 386 according to the embodiments of the present disclosure. The payment list 386 includes a post payment button 388, a start date and an end date input 389, a search button 390 and a payment information card 391. The post payment button 388 is a clickable button that brings up a post payment modal to allow users to input payments. The start date and an end date input 389 is a user input for dates that filter data to the data range between the start date and the end date. The search button 390 is a clickable button that executes a search for payments based on the start and end date inputs. The payment information card 391 received date is clickable and brings the user to a screen with payment details.

FIG. 3M illustrates an exemplary post payment modal 391 according to the embodiments of the present disclosure. The post payment modal 391 includes a calendar button 392, a net prepay received 393, a customer name input 394, a prepay received input 395, an add another customer button 396, and a post payment button 397. The calendar button 392 is a clickable calendar button that displays a calendar for a user to select a date. The net prepay received 393 is an information filed that is the sum of all prepay received rows. The customer name input 394 is a user input company that paid for COTs. The prepay received input 395 is a user input for a monetary amount received by the company. The add another customer button 396 is a clickable button that adds an additional customer name and prepay received inputs if more than three payments have been received. The post payment button 397 is a clickable button that creates a payment for each customer name or prepay received combo.

FIG. 3N illustrates an exemplary associates COTs 1300 according to embodiments of the present disclosure. The associated COTs 1300 includes a payments list link 1301, a clear payments button 1302, a cancel button 1303, a save button 1304, an expandable drawer 1305, a prepay applied input 1306, a company select dropdown 1307, a comments icon 1308, and an action list 1309. The payments list link 1301 is a clickable link that takes the user back to the payment list screen. The clear payments button 1302 is a clickable button that will make all prepay applied inputs equal to $0. The cancel button 1303 is a clickable button that replaces the associate COTs with the payment applied screen. The save button 1304 is a clickable button that will pay for all COTs with a prepaid applied greater than $0 and can take the user to the payment applied screen. The expandable drawer 1305 is a clickable arrow that can show all the COTs won on the bid date. The prepay applied input 1306 is a user input to apply money to pay for COTs won on the bid date. The company select dropdown 1307 is a dropdown menu with companies that have made payments on the received date and selecting a company can show COTs that can be paid for by the selected company. The comments icon 1308 allows a user to hover over the icon to see a comment when the payment has a comment. The action list 1309 includes actions to take on the selected payment. The actions includes edit payment action as a clickable option that opens up the edit payment modal to make adjustments to the active payment and a delete payment action as a clickable option that opens a confirmation modal asking the user if they want to permanently delete the payment.

FIG. 3O illustrates an exemplary edit payment modal 1310 according to the embodiments of the present disclosure. The edit payment modal 1310 includes a received date 1311, a prepay received date 1312, a write-off amount input 1313, a refund amount input 1314, a comment input 1315 and an update button 1316. The received date 1311 is information only and not to be updated through calendar. The prepay received date 1312 is a user input relating to an amount of money received by the active customer. The write-off amount input 1313 is a user input relating to an amount of money to write-off for the active customer. The refund amount input 1314 is a user input relating to an amount of money to refund for the active customer. The comment input 1315 is a section for a user or admin to write notes about an active payment. The update button 1316 is a clickable button that can update the active payment with all the user inputs.

FIG. 3P illustrates an exemplary payment applied window 1317 according to the embodiments of the present disclosure. The payment applied window 1317 includes an associates COTs button 1318, an expandable drawer 1319, and an action list 1320. The associates COTs button 1318 is a clickable button that takes the user to the “associate COTs screen.” The expandable drawer 1319 is a clickable arrow that can show all the COTs won on the bid-date. The action list 1320 includes actions to take on a specific COT. The actions include edit that is a clickable link that allows the user to edit the payment on the COT and a cancel action that is clickable link that allows the user to unpay the COT and disassociate it from the active payment.

FIG. 3Q illustrates an exemplary cancel/uncancel COTs window 1321 according to the embodiments of the present disclosure. The cancel/uncancel COTs window 1321 includes a shipping month and year filter 1322, a period filter 1323, a customer search 1324, a find customers button 1325 and an actions list 1326. The shipping month and year filter 1322 is a user input to filter the data based on the month and the year. The period filter 1323 is a user input to filter data based on the period. The customer search 1324 is a user input to filter data based on the company name. The find customers button 1325 is a clickable button to execute a search based on a user input. The actions list 1326 is a hover over a dropdown menu to display actions. The actions includes a cancel COTs that takes a user to a new screen to cancel COTs and an uncancel COTs that takes a user to a new screen to uncancel COTs.

FIG. 3R illustrates an exemplary cancel/uncancel COTs detail window 1327 according to the embodiments of the present disclosure. The cancel/uncancel COTs detail window 1327 includes a COT management link 1328, a select all button 1329, a deselect all button 1330, a cancel/uncancel COTs button 1331, a select checkbox 1332, and a not billable box 1333. The COT management link 1328 is a clickable link to take a user back to the “cancel/uncancel COTs” screen. A select all button 1329 is a clickable action to select all records on the screen. The deselect all button 1330 is a clickable action to deselect all records on the screen. The cancel/uncancel COTs button 1331 is a button to execute the cancel or uncancel action to the selected records on the page. The button that is displayed depends on which action is taken from the “cancel/uncancel COTs” screen. The select checkbox 1332 is a user input to select the record. The not billable box 1333 is a user input to select whether a bill should not be sent to the customer.

FIG. 3S illustrates an exemplary units to DET screen 1332 according to the embodiments of the present disclosure. The units to DET screen 1332 includes a customer search 1333, a unit search 1334, and a combine units button 1335. The customer search 1333 is a user input to filter data based on a company name. The unit search 1334 is a user input to search for specific COT numbers. The combine units button 1335 is a clickable button that appears when four records are on the screen. Clicking the button can take the user to a confirmation modal to made additional selections.

FIG. 3T illustrates an exemplary units to DET modal 1336 according to the embodiments of the present disclosure. The units to DET modal 1336 includes a DET shipping month and year 1337, a DET period 1338, and a combine units button 1339. The DET shipping month and year 1337 is a user input to choose a month and year the DET is created, The DET period 1338 is a user input to choose a time frame in a month the DET can be used. The combine units button 1339 is a clickable button to combine the selected units into a DET COT.

FIG. 3U illustrates an exemplary DET to units list 1340 according to embodiments of the present disclosure. The DET to units list 1340 includes a COT number drawer 1341 and an uncombine action 1342. The COT number drawer 1341 is a clickable arrow to show the details of what unit COTs made the DET COT. The uncombine action 1342 is a clickable link that displays a confirmation modal indication of the DET record.

FIG. 3V illustrates an exemplary DET to unit modal 1343 according to embodiments of the present disclosure. The DET to unit modal 1343 includes an uncombine DET button 1344 that is a clickable button that confirms the action of uncombining the DET and uncancelling the COTs shown.

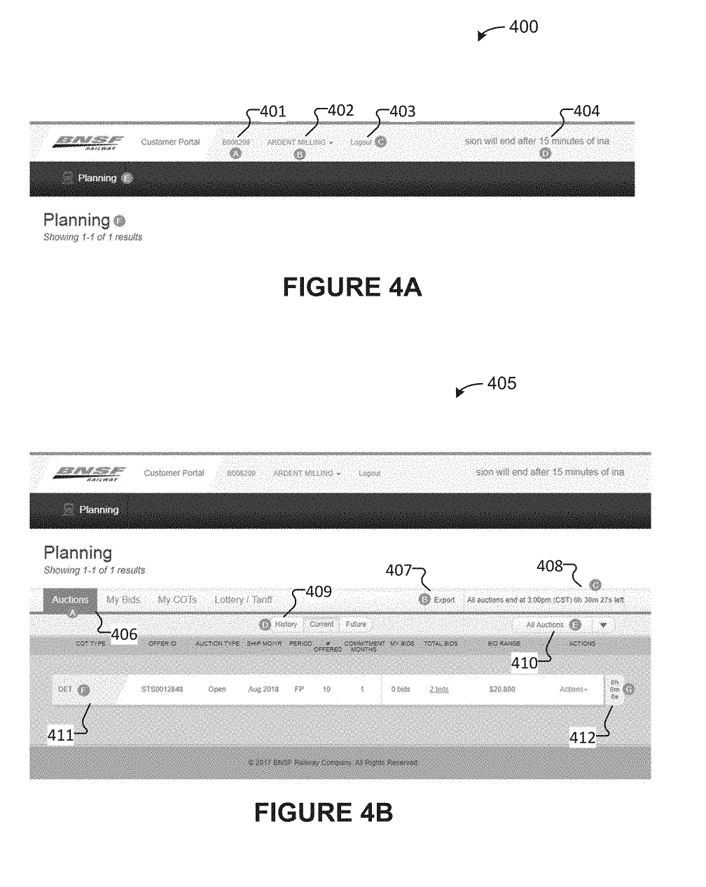

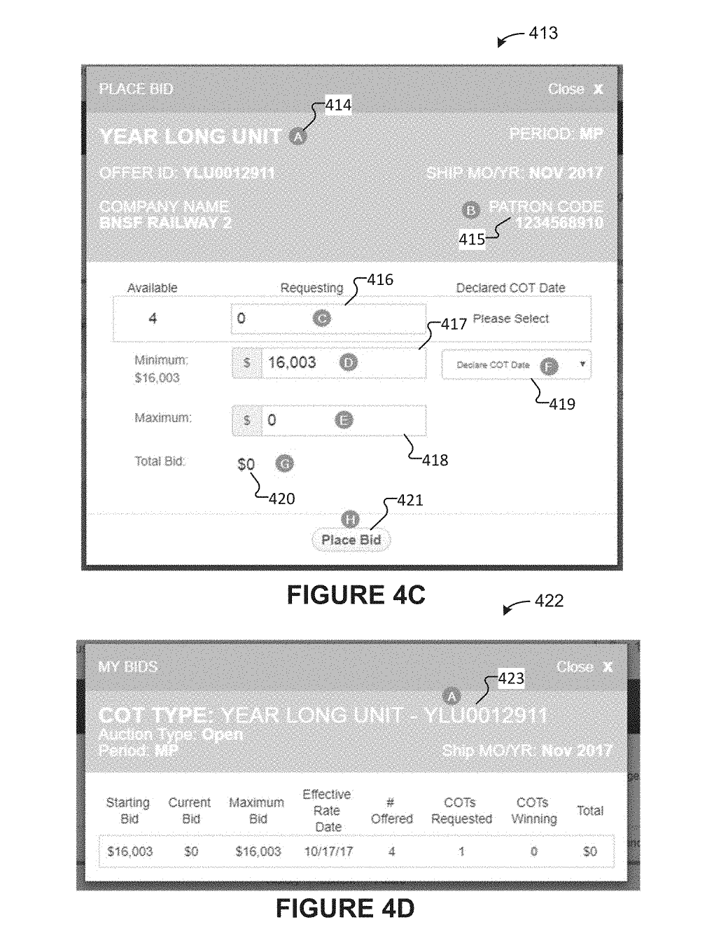

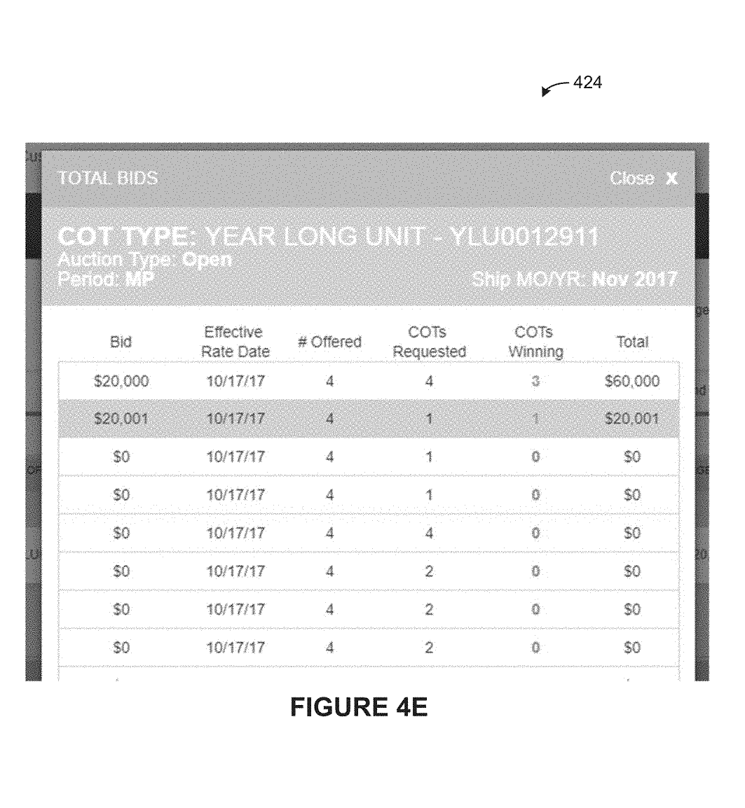

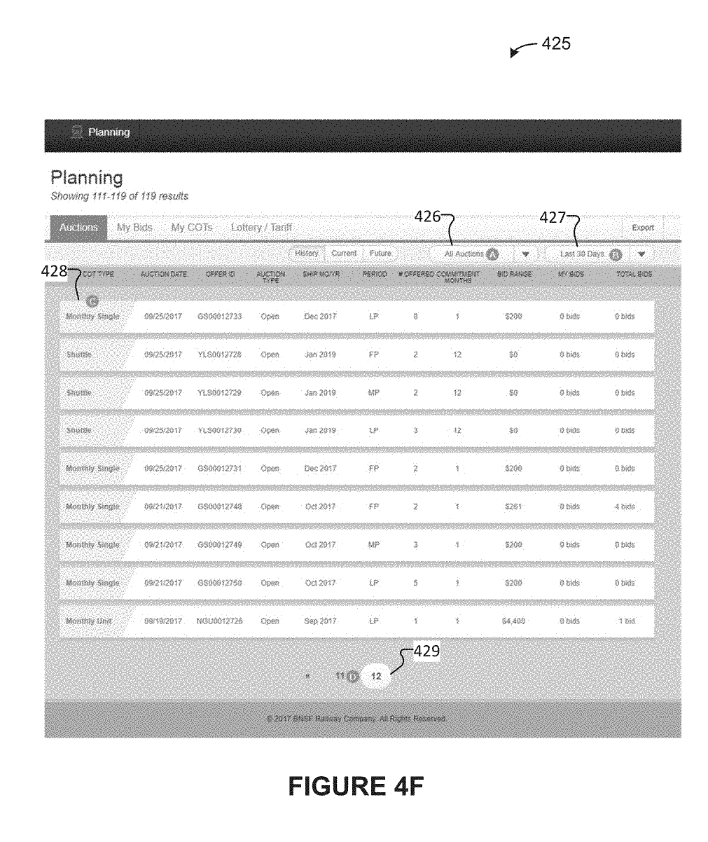

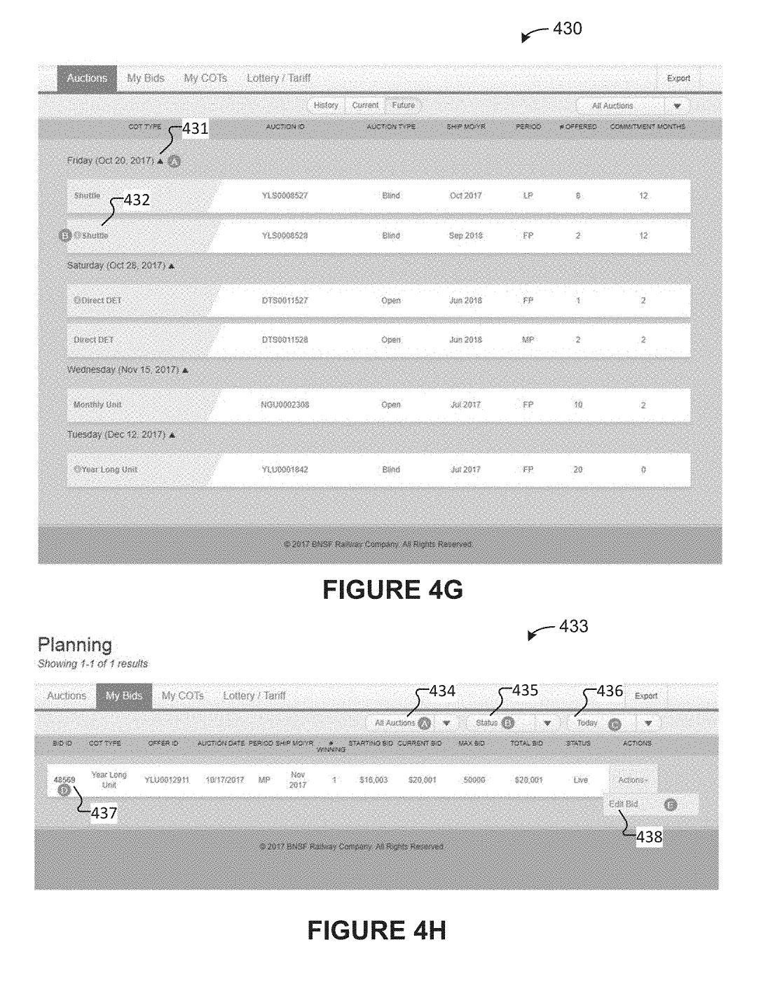

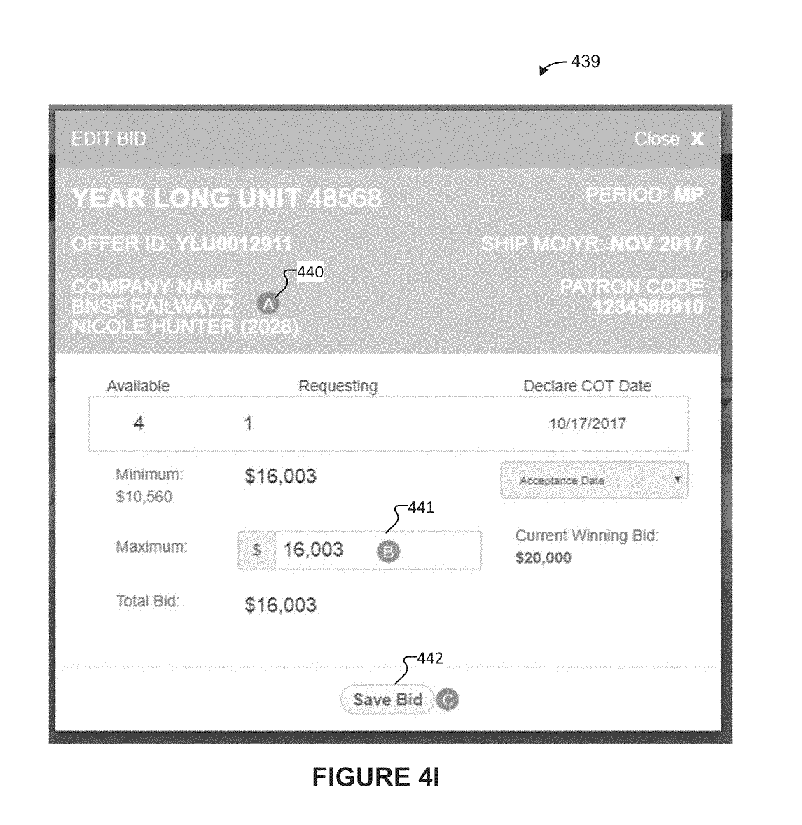

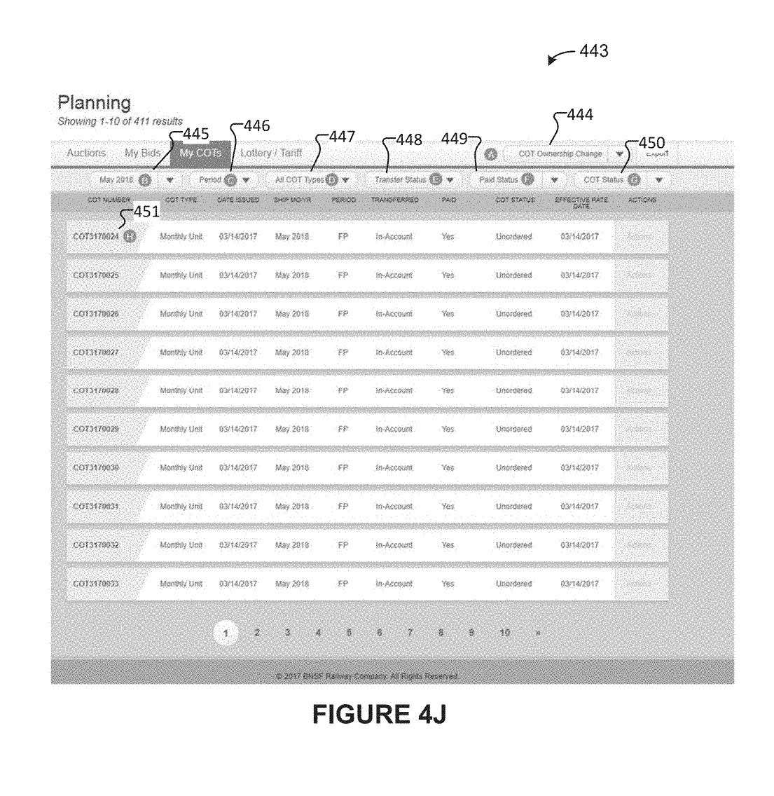

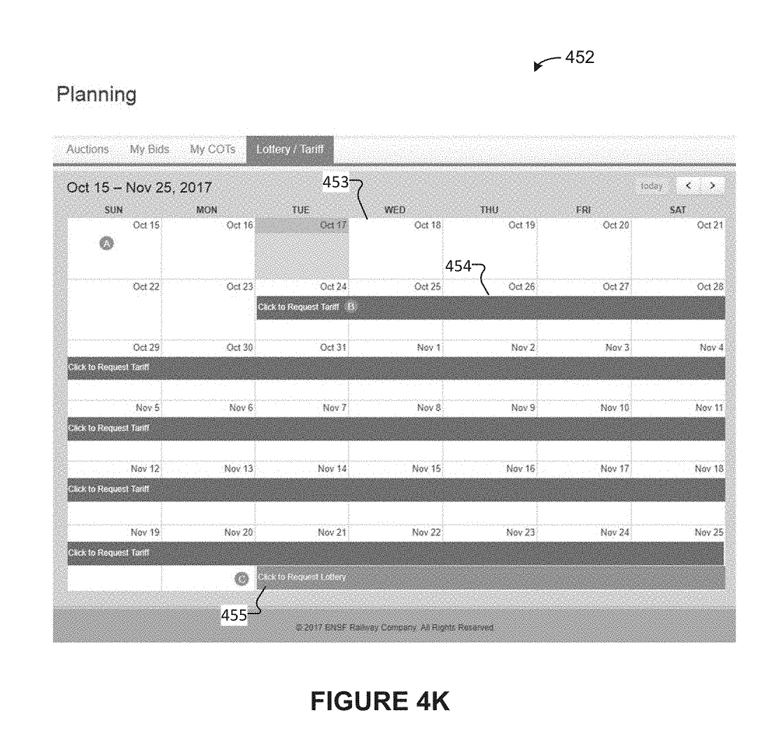

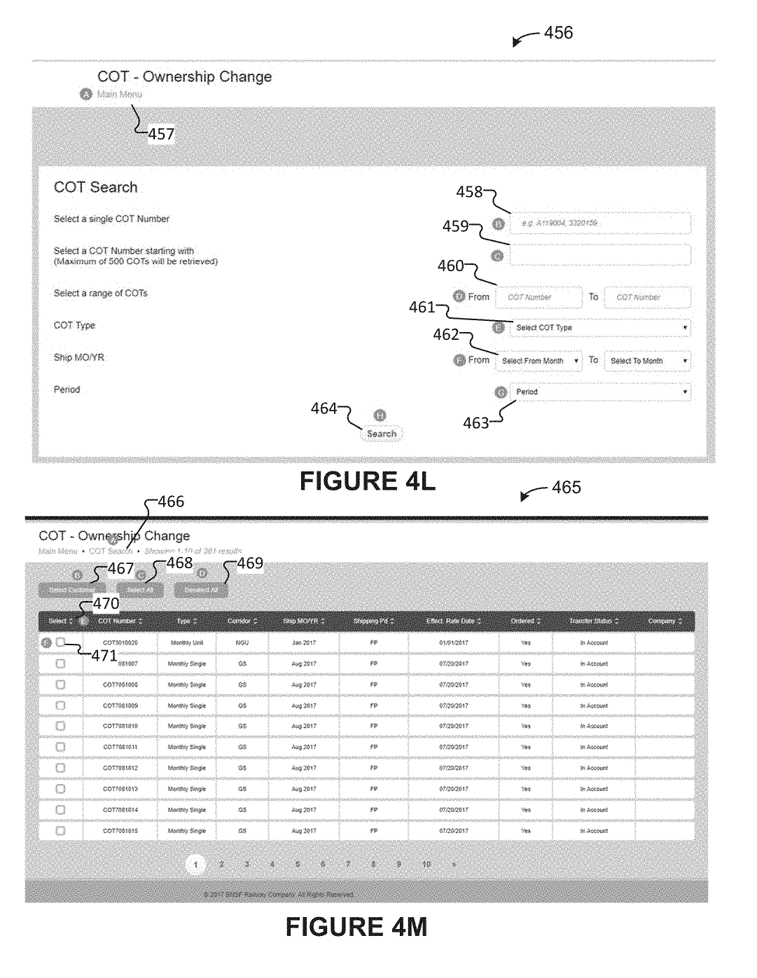

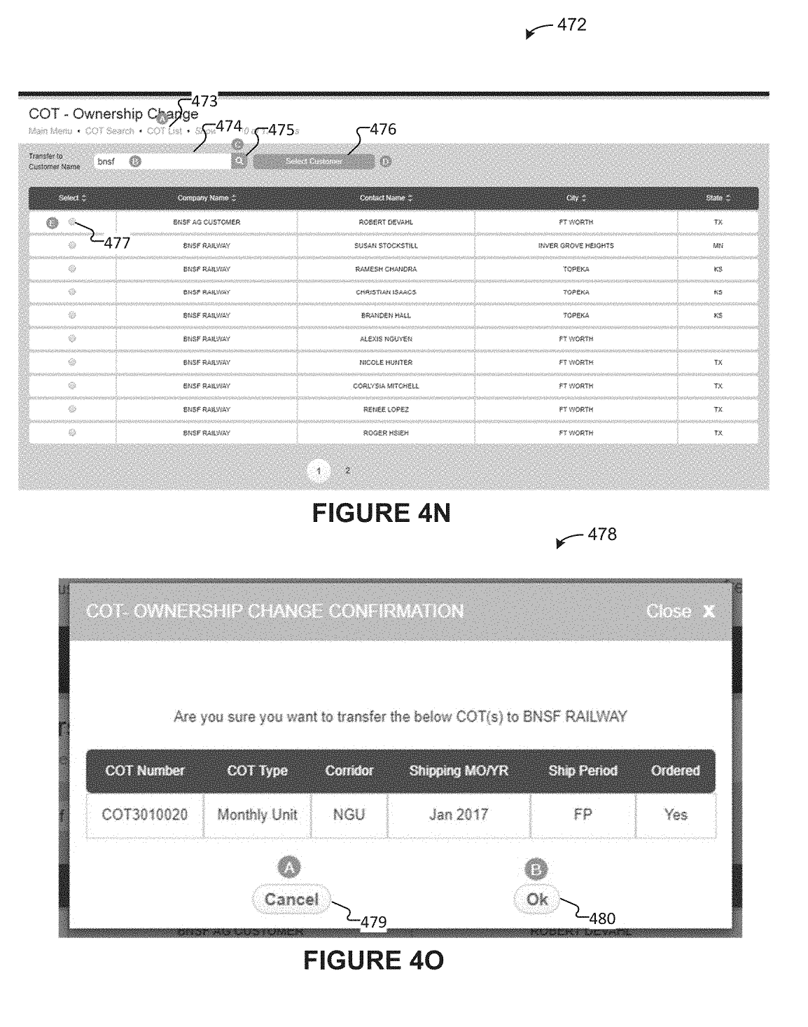

FIGS. 4A-4O are diagrams of a customer port graphical user interface 400 according to a representative embodiment of the present principles. The embodiment of the customer port graphical user interface 400 is illustration only. FIG. 14 does not limit the scope of this disclosure to any particular implementation of a customer port graphical user interface.

The COTs customer portal UI 400 includes a user ID 401, a company name 402, a user logout 403, inactivity message 404, a high-level section, and a currently-selected section. The user ID 401 is a display of the user name. The company name 402 is a dropdown that consists of all companies associated with a currently logged in user. The company shown is the “active” company. The user logout 403 is a clickable link to log out of the application. The inactivity message 404 a message telling user that they will be logged out after a period of time. Any action taken after the period of time will kick the user out and ask the user to log back in. The high-level section is a clickable link for a high-level section of the application. The currently-selected section is the high-level section that is currently selected and displayed.

FIG. 4B illustrates an exemplary current auctions page 405. The current auctions pages can get the data refreshed whenever a bid is placed. The page also can refresh when an auction goes live or closes. The current auction page 405 includes a selected sub-section 406, an export input 407, a timer 408, an auction time period 409, an auction filter input 410, at least one auction card 411, and a specific timer 412. The selected sub-section 406 highlights the currently selected sub-section. The export input 407 allows a currently selected sub-section to have contents exported to an external document, such as a pdf document or an excel document. The timer 408 displays when an auction ends and is a default time. The auction time period 409 provides auction time periods including history period, current period and future period. The history period is for auctions that have ended. The current period is for live auctions. The future period is for all auctions that have yet to go live. The active selection looks like a pressed button. The auction filter input 410 is a filter user to narrow down data to a specific COT type. The auction card 411 includes a COT type, an offer ID, an auction type, a shipping month and year, a period, a number offered, a commitment months, a my bids, a total bids, a bid range, and an action list. The COT type is a type of COT being offered. The offer ID is a unique identifier for the auction. The auction type indicates an open auction or a blind auction. The shipping month and year indicates a year and a month the Cot is active for or a starting month for COTs with a longer commitment. The period is one of three periods. The first period, the middle period or the last period specify when in the month the COT can be used. The number offered is a number of COTs being offered. The commitment months is a length of time certain types of COTs are valid for. The commitment months can be used for COTs that are issued for multiple months. The my bids is a number of bids placed by a user or company combination. The my bids includes a clickable display pop up when the current user has placed at least one bid. See “My Bids Details Modal” for more information. The total bids is a total number of bids on the auction. The total bids is a clickable button to display a popup for all bids. See “total bids detail modal” for more information. The bid range is a current auction price. The action list is a list of actions a use can take on the offer. The action list includes a create bid action that displays a modal for a user to enter bid information and submit a bid to auction. See “place bid modal’ for more information. The specific timer 412 is a timer displayed when an auction ends at a different time from the timer 408.

FIG. 4C illustrates an exemplary place bid modal 413 according to embodiments of the present disclosure. The place bid modal 413 includes a COT type 414, a patron code 415, a number requesting 416, a minimum 417, a maximum 418, a declared COT date 419, a total bid 420 and a place bid button 421. The COT type 414 is a COT type that the bid is being placed on. The patron code 415 is a billing identifier for a customer. The number requesting 416 is a user input for how many COTs the customer wants to place a bid on. The minimum 417 is a user input for the minimum starting price for the bidding. The minimum 417 is a field that starts at the current auction floor or the overall bid minimum. The maximum 418 is a user input for the highest price a user is willing to bid for a COT. The declared COT date 419 is a user input from a dropdown menu that indicates what billing rate to user for the COTs if the user is a winner. The date entered can either be the date the bid is placed or the first day the COT is eligible to be used. Option shown depend on the COT type being offered in the auction. The total bid 420 is a calculation of COTs requested multiplied by the maximum 418. The result indicates the highest possible price a user would have to pay. The place bid button 421 is a clickable button that submits the bid.

FIG. 4D illustrates an exemplary MyBids detail modal 422 according to the embodiments of the present disclosure. The MyBids detail modal 422 gives the user a quick view of all bids placed by the same company as the user. The MyBids detail modal 422 includes an offerID 423.

FIG. 4E illustrates an exemplary total bid detail modal 424 according to embodiments of the present disclosure. The total bid detail modal 424 gives the user a quick view of all bids placed on the auction. The highlighted rows show bids made by the same company as the user.

FIG. 4F illustrates an exemplary history 425 according to embodiments of the present disclosure. The history includes a COT/Auction type filter 426, a time period filter 427, at least one auction information card 428, and a pagination bar 429. The COT/Auction type filter 426 is a user input that filters the auction information cards 428 by selected types. The time period filter 427 is a user input that filter the auction information cards 428 based on a timer period the last 30 days, last three months, the last six months, and the last year. The least one auction information card 428 includes the same information as auction card 411. The pagination bar 429 displays only if the total number of possible records is greater than 10. The pagination bar can cycle through the auction cards 428 in groups.

FIG. 4G illustrate an exemplary future modal 430 according to the embodiments of the present disclosure. The future modal 430 includes an auction date 431 and an auction comment indicator 432. The auction date 431 is a high level grouping of auction for a day. The data for each day is collapsible. The auction comment indicator 432 is an indicator to show there is a comment on an auction. When the user hovers over the indicator, the comment is displayed. This comment feature is present in the current and history auctions.

FIG. 4H illustrates an exemplary MyBid tab 433 according to embodiments of the present disclosure. The MyBid tab 433 includes an auction type filter 434, a bid status filter 435, a time period filter 436, a bid card 437 and an action list 438. The auction type filter 434 is a user input to filter the bid cards 437 based on the auction type. The bid status filter 435 is a user input that is used to filter the bid cards 437 based on the bid status. The bid status include one of three statuses. A live status is a bid that is in a currently live auction. A won status is a bid that has won an auction. A lost status is a bad that did not win in an auction. A cancelled status is a bid that was cancelled either by the user or the COT admin. The time period filter 436 is a user input user to filter the bid card 437 based on the time period. The bid card 437 is a card showing a user's bid with both auction and bid information. The action list 438 for a bid that is a live status can have an “edit bid” option that can bring up the “edit bid modal.” If the auction is a blind auction, a cancel bid option will appear.

FIG. 4I illustrates an exemplary edit bid modal 439 according to the embodiments of the present disclosure. The edit bid modal 439 includes a bidder information 440, an edit maximum 441, a save bid button 442. The bidder information 440 is information on who placed a bid from the company. Anyone in the same company can see and edit bids. The edit maximum 441 is a user input to edit the highest amount a user is willing to bid. The maximum cannot be lowered from the initial maximum. The save bid button 442 is a clickable button user to submit the edited bid.

FIG. 4J illustrates an exemplary MyCOTs modal 443 according to embodiments of the present disclosure. The MyCOTs modal 443 includes a COT ownership change 444, a shipping month and year filter 445, a period filter 446, a COT type filter 447, a transfer status filter 448, a paid status filter 449, a COT status filter 450, and a COT card 451. The COT ownership change 444 is a user input dropdown menu that takes a user to screens to transfer the ownership of a COT. Different transfers of ownership include an initiate transfer that takes the user to a search screen to start the process of transferring a COT, an accept/reject that takes the user to the COT list screen to accept or reject a transfer, and a cancel transfer that takes the user to a COT list screen to cancel a transfer. The shipping month and year filter 445 is a user input dropdown menu that is used to filter COT data by a specific year and month. The period filter 446 is a user input dropdown mend used to filter COT data by a specific period. The COT type filter 447 is a user input dropdown menu user to filter COT data by a specific COT type. The transfer status filter 448 is a user input dropdown menu used to filter COT data by a transfer status. The paid status filter 449 is a user input dropdown menu to filter COT data by paid status. The COT status filter 450 is a user input dropdown menu to filter COT data by COT status.

The COT card 451 displays information about a user's COT. The COT card includes a COT number, a COT type, a date issued, a shipping month/year, a period, a transfer status, a paid status, a COT status, and an action list. A COT number is a unique identifier for a COT. The COT type is the type of the COT. A date issued is a date that the COT was given to the user. A shipping month/year is a month and year that the COT can be used. The period is a time of the shipping month/year that the COT can be used. A transfer status is a status showing where the COT is in the transfer process. Examples of transfer status include in-account status that a COT is owned by a user and not in the act of being transferred, pending-in status where a COT is waiting to be accepted by the user, a pending out status where the COT is waiting for new owner to accept, and a transferred status where the COT has been transferred from the user to a new owner. The paid status is an indicator whether the COT has been paid for. The COT status includes ordered/cancelled information about the COT. Examples of order/cancelled information includes near cancellation information where the COT needs to be used in the next ten days, a cancelled information where the COT has been canceled and cannot be used, an order accepted information where the COT has been used, and an unordered information where the COT has not yet been used. The action list includes actions that can be applied to the COT card 451.

FIG. 4K is an exemplary lottery/tariff tab 452 according to the embodiments of the present disclosure. The lottery/tariff tab 452 includes a calendar 453, a request tariff 454, and a request lottery 455. The calendar 453 is a rolling six week calendar with the current week on top. The request tariff 454 is a time period in which a tariff car can be ordered. A user can click the bar to be taken to the application that allows the user to order a tariff car. The request lottery 455 is a time period in which a lottery car can be ordered. A user can click the bar to be taken to the application that allows the user to place a lottery bid.

FIG. 4L illustrates an exemplary COT search 456 according to embodiments of the present disclosure. The COT search 456 includes a main menu link 457, a single COT number search 458, a COT starting with search 459, a COT range search 460, a COT type search 461, a shipping month/year search 462, a period search 463, and a search button 464. The main menu link 457 is a clickable link that takes a user back to the COTs tab. The single COT number search 458 is a user input to search on a single COT number. The COT starting with search 459 is a user input to search beginning with a COT number. The COT range search 460 is a user input to search between two COT numbers. The COT type search 461 is a user input dropdown menu to select Cot type to search. The shipping month/year search 462 is a user input dropdown to search for COTs between two shipping months and years. The period search 463 is a user input dropdown menu to search for a specific period. The search button 464 is a clickable button to search the COTs based on the user inputs.

FIG. 4M illustrates an exemplary COT list 465 according to the embodiments of the present disclosure. The COT list 465 includes a COT search link 466, an action button 467, a select all button 468, a deselect all button 469, sortable headers 470, and a select checkbox 471. The COT search link 466 is a clickable link to take a user to the search screen. The action button 467 is a button that can be one of three actions depending on what is selected from the “Planning Section (MyCots) items A dropdown.” When the select customer is selected, the action button 467 takes a user to a screen to search for a person to transfer selected COTs to. When the accept transfer and reject transfer is selected, the action button 467 has two button displayed. Where the accept transfer button can process the transfer of all selected COTs and the reject transfer button can stop the process of all selected COTs. When the cancel transfer is selected, the action button 467 can present user with confirmation to cancel the transfer of selected records.

The select all button 468 is a user input to select all records on the screen. The deselect all button 469 is a user input to deselect all records on the screen. The sortable headers 470 is a user input link on a header to sort the entire column alphabetically ascending and descending. The select checkbox 471 allows a user to select or deselect a COT to be transferred.

FIG. 4N illustrates an exemplary customer search 472 according to embodiments of the present disclosure. The customer search 472 includes a COT list 473, a customer search field 474, a magnifying glass button 475, a select customer button 476, and a select row radio button 477. The COT list 473 is a clickable link to take a user back to the COT list page. The customer search field 474 is a user input search bar to search for a company to transfer the previously selected COT(s) to. The magnifying glass button 475 fetches results based on the user input from the customer search field when clicked. The select customer button 476 is a button that appears after a search has been executed. Once a record has been selected, a confirmation modal can appear. The select row radio button 477 is a user input to select a person to transfer the previously selected COTs to.

FIG. 4O illustrates an exemplary transfer confirmation modal 478 according to embodiments of the present disclosure. The transfer confirmation modal 478 includes a cancel button 479 and an accept button 480. The cancel button 479 closes the current modal and returns a user to the customer search screen. The accept button 480 initiates the transfer to the backend and take the user to the COT search with a success confirmation.

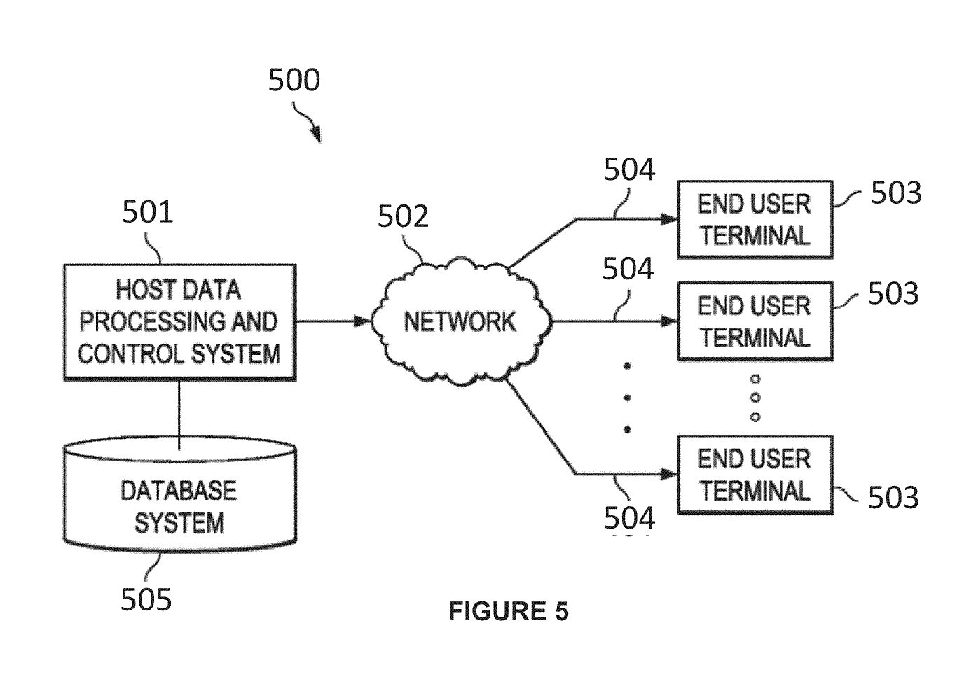

FIG. 5 illustrates an exemplary high level functional block diagram illustrating a representative computer network operating environment in which the principles of the present invention can advantageously be applied. In the illustrated embodiment, system 500 is based on a host data processing and control system (server) 501 and a global network 502, such as the Internet. Global network 502 could also be a private, organizational, or governmental computer-based network known in the art, such as a wide area network (WAN) or local area network (LAN). The interconnections between the operational blocks shown in system 500 shown in FIG. 5 can be implemented by hardwired connections, wireless connections, or a combination of the two.

Generally, the application of the principles of the present invention is independent of the high-level architecture and high-level hardware-software implementation of system 500. System 500 allows a user (e.g., a railroad customer or railroad) to monitor and manage certificates of transportation using an end user terminal 503, railroad host server 501 and associated database 505, communications interconnections 504, and network 502. End user terminals 503, may be, for example, a desk top computer, laptop computer, tablet, mobile phone, or similar conventional computing-communications device, which supports standard network interfacing through browsers or applications. In the typical operating environment, system 500 will have multiple users, including those employed by the railroad and those employed by the customer, and a corresponding number of end user terminals 503, although only three end user terminals 503, and a corresponding number of communications interconnections 504, are shown in FIG. 5 for reference.

The subsystems of system 500, including railroad host server 501, database 505, and communications interconnections 504 are preferably based on hardware and software systems known in the art, including computers, servers, processors, displays, and communications systems. Depending on the particular configuration of system 500 being employed, the base hardware and software can be, in whole or in part, localized (e.g., at a geographically centralized data center) or distributed (e.g., at multiple geographically-diverse processing nodes).

Although the invention has been described with reference to specific embodiments, these descriptions are not meant to be construed in a limiting sense. Various modifications of the disclosed embodiments, as well as alternative embodiments of the disclosure, can become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present disclosure. It should also be realized by those skilled in the art that such equivalent constructions do not depart from the spirit and scope of the disclosure as set forth in the appended claims.

It is therefore contemplated that the claims can cover any such modifications or embodiments that fall within the true scope of the disclosure.

The description in this patent document should not be read as implying that any particular element, step, or function is an essential or critical element that must be included in the claim scope. Also, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. § 112(f).

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods can be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for managing certificates of transportation (COTs) comprising:
a plurality of user terminals each including a display screen for presenting a graphical user interface and output information;
a network communicating with the plurality of user terminals; and
a COT processing system communicating with the plurality of user terminals and operable to perform winner determination logic,
wherein the plurality of user terminals includes:
an admin terminal configured to initiate a COT auction for a COT;
a first customer terminal configured to place a first bid in the COT auction; and
a second customer terminal configured to place a second bid in the COT auction, and
wherein the COT processing system is configured to:
determine a winner of the COT auction between the first bid and the second bid using the winner determination logic, and
issue the COT according to the determined winner.

2. The system of claim 1, wherein the COT processing system is further configured to:
determine a current winning bid of the COT auction when the second bid is placed;
notify a current losing bid of the COT auction that a bid placed by the current losing bid is no longer in consideration for the COT auction.

3. The system of claim 2, wherein the current winning bid is determined based on a higher amount between a first maximum bid for the first bid and a second maximum bid for the second bid.

4. The system of claim 2, wherein:
a threshold minimum bid is set by the admin terminal as part of the COT auction;
when a current winning bid of the COT auction is determined, the COT processing system is further configured to increase the threshold minimum bid to an increment bid more than a maximum bid for the current losing bid for future bids placed by other customer terminals.

5. The system of claim 2, wherein:
the COT auction is for a plurality of COTs,
the plurality of user terminals includes:
a third customer terminal configured to place a third bid in the COT auction; and
a fourth customer terminal configured to place a fourth bid in the COT auction, wherein the COT processing system is further configured to:
create a list containing the first bid, the second bid, the third bid, and the fourth bid,
determine whether a number of COTs requested by bids placed is less than or equal to the number of COTs offered in the COT auction, and
allocate the COTs based on a determination of the number of COTs requested compared to the number of COTs offered.

6. The system of claim 5, wherein the COT processing system is further configured to:
when the number of COTs requested is less than or equal to the number of COTs offered, allocate the COTs based on a minimum bid amount for each of the bids.

7. The system of claim 5, wherein, when the number of COTs requested is less than or equal to the number of COTs offered, the COT processing system is further configured to:
sort the bids by a maximum bid amount for each of the bids,
sort the bids by a time placed for each of the bids,
allocate COTs in order of the sorted bids,
determine whether all winning bids won the number of COTs requested, and
set a price for each COT based on a determination of the all winning bids winning the number of COTs requested.

8. The system of claim 7, wherein:
the COT processing system is further configured to when the all winning bids are winning the number of COTs requested, set the price for each COT based on a first losing bid,
the first losing bid is a bid with a maximum bid that does not win a COT auction,
a next winning bid is equal to the maximum bid of the first losing bid, when the next winning bid is placed before the first losing bid, and
the next winning bid is equal to a bid increment added to the maximum bid of the first losing bid, when the next winning bid is placed after the first losing bid.

9. The system of claim 7, wherein:
the COT processing system is further configured to when the all winning bids are not winning the number of COTs requested, set the price for each COT based on a last winning bid,
the last winning bid is a bid with a maximum bid that win a portion of number of bids that does not win COT auction,
a next winning bid is equal to the maximum bid of the last winning bid, when the next winning bid is placed before the last winning bid, and
the next winning bid is equal to a bid increment added to the maximum bid of the last winning bid, when the next winning bid is placed after the last winning bid.

10. A method for managing certificates of transportation (COTs) using a plurality of user terminals each including a display screen for presenting a graphical user interface and output information, a network communicating with the plurality of user terminals, and a COT processing system communicating with the plurality of user terminals and operable to perform winner determination logic, wherein the method includes:
initiating, by an admin terminal of the plurality of user terminals, a COT auction for a COT received from an admin terminal;
placing, by a first customer terminal of the plurality of user terminals, a first bid in the COT auction;
placing, by a second customer terminal of the plurality of user terminals, a second bid in the COT auction;
determining, by the COT processing system, a winner of the COT auction between the first bid and the second bid using the winner determination logic; and
issuing, by the COT processing system, the COT according to the determined winner.

11. The method of claim 10, further comprising:
determining, by the COT processing system, a current winning bid of the COT auction when the second bid is placed;
notifying, by the COT processing system, a current losing bid of the COT auction that a bid placed by the current losing bid is no longer in consideration for the COT auction.

12. The method of claim 11, wherein the current winning bid is determined based on a higher amount between a first maximum bid for the first bid and a second maximum bid for the second bid.

13. The method of claim 11, wherein a threshold minimum bid is set by the admin terminal as part of the COT auction;
when a current winning bid of the COT auction is determined, the method further comprises increasing the threshold minimum bid to an increment bid more than a maximum bid for the current losing bid for future bids placed by other customer terminals.

14. The method of claim 11, wherein:
the COT auction is for a plurality of COTs, and
the method further comprising:
placing, by a third customer terminal of the plurality of user terminals, a third bid in the COT auction;
placing, by a fourth customer terminal of the plurality of user terminals, a fourth bid in the COT auction,
creating, by the COT processing system, a list containing the first bid, the second bid, the third bid, and the fourth bid,
determining, by the COT processing system, whether a number of COTs requested by bids placed is less than or equal to the number of COTs offered in the COT auction, and
allocating, by the COT processing system, the COTs based on a determination of the number of COTs requested compared to the number of COTs offered.

15. The method of claim 14, further comprising:
when the number of COTs requested is less than or equal to the number of COTs offered, allocating, by the COT processing system, the COTs based on a minimum bid amount for each of the bids.

16. The method of claim 14, when the number of COTs requested is less than or equal to the number of COTs offered, further comprising:
sorting, by the COT processing system, the bids by a maximum bid amount for each of the bids,
sorting, by the COT processing system, the bids by a time placed for each of the bids,
allocating, by the COT processing system, COTs in order of the sorted bids,
determining, by the COT processing system, whether all winning bids won the number of COTs requested, and
setting, by the COT processing system, a price for each COT based on a determination of the all winning bids winning the number of COTs requested.

17. The method of claim 16, further comprising, when the all winning bids are winning the number of COTs requested, setting, by the COT processing system, the price for each COT based on a first losing bid,
wherein:
the first losing bid is a bid with a maximum bid that does not win a COT auction,
a next winning bid is equal to the maximum bid of the first losing bid, when the next winning bid is placed before the first losing bid, and
the next winning bid is equal to a bid increment added to the maximum bid of the first losing bid, when the next winning bid is placed after the first losing bid.

18. The method of claim 16, further comprising, when the all winning bids are not winning the number of COTs requested, setting, by the COT processing system, the price for each COT based on a last winning bid,
wherein:
the last winning bid is a bid with a maximum bid that win a portion of number of bids that does not win COT auction,
a next winning bid is equal to the maximum bid of the last winning bid, when the next winning bid is placed before the last winning bid, and
the next winning bid is equal to a bid increment added to the maximum bid of the last winning bid, when the next winning bid is placed after the last winning bid.

19. A non-transitory computer-readable medium storing instructions that, when executed, causes a processor to:
initiate, by an admin terminal, a COT auction for a COT received from an admin terminal;
place, by a first customer terminal, a first bid in the COT auction;
place, by a second customer terminal, a second bid in the COT auction;
determine, by a COT processing system, a winner of the COT auction between the first bid and the second bid using winner determination logic; and
issue, by the COT processing system, the COT according to the determined winner.

20. The non-transitory computer-readable medium of claim 19, wherein the instructions further cause the processor to:
place, by a third customer terminal, a third bid in the COT auction;
place, by a fourth customer terminal, a fourth bid in the COT auction,
create, by the COT processing system, a list containing the first bid, the second bid, the third bid, and the fourth bid,
determine, by the COT processing system, whether a number of COTs requested by bids placed is less than or equal to the number of COTs offered in the COT auction, and
allocate, by the COT processing system, the COTs based on a determination of the number of COTs requested compared to the number of COTs offered.
